(19) United States
(12) Patent Application Publication
(10) Pub. No.: US 2025/0312211 A1
(43) Pub. Date: Oct. 9, 2025

(54) Powered Wheel for a Wheelchair

(71) Applicant: CONCOURSE IP PTY LTD, Sydney (AU)

(72) Inventors: Oscar Enrique Perez Ulloa, Sydney (AU); Jonathan Andrew Eggins, Sydney (AU); David Michael Mackay, Sydney (AU)

(21) Appl. No.: 18/860,513

(22) PCT Filed: Apr. 27, 2023
(86) PCT No.: PCT/AU2023/050344

§ 371 Date: Oct. 25, 2024

(30) Foreign Application Priority Data
Apr. 27, 2022 (AU) 2022901109
Nov. 28, 2022 (AU) 2022903596

(51) Int. Cl. A61G 5/04; A61G 5/10

(52) U.S. Cl. CPC A61G 5/047; A61G 5/045; A61G 5/1008; A61G 5/1054; A61G 2203/14; A61G 2203/36

(57) ABSTRACT

Disclosed is a drive unit of a powered wheel for a wheelchair. The drive unit comprises a battery for powering the drive unit and an electric motor for driving the powered wheel. The drive unit also comprises at least one retractable locking pin for engaging the drive unit with the wheelchair to allow the electric motor to drive the wheelchair.

### TECHNICAL FIELD

The present invention generally relates to a power wheel and more particularly to powered wheel for use on a wheelchair.

### BACKGROUND

Wheelchairs provide mobility for many people. A standard wheelchair is manually operated with a wheelchair user providing the driving force to the wheels with their hands on a hand rim, also referred to as a push ring, which forms part of the wheel. However, manual wheelchairs are not suitable for all users.

An electric wheelchair provides an alternative to a manual wheelchair for users who are unable to use a manual wheelchair or other mobility solutions. An electric wheelchair often uses a different design to a manual wheelchair, with an electric motor, batteries and control systems built into the chair. Typically the motor and control systems are located below the seat and built into the chair. Such a design can prevent the chair from folding for easier portability when the user is no longer in the chair.

The preferred embodiments of the present invention seek to address a plurality of these disadvantages, to provide the public with a useful innovation.

The reference in this specification to any prior publication (or information derived from the prior publication), or to any matter which is known, is not, and should not be taken as an acknowledgement or admission or any form of suggestion that the prior publication (or information derived from the prior publication) or known matter forms part of the common general knowledge in the field of endeavour to which this specification relates.

### SUMMARY

This Summary is provided to introduce a selection of concepts in a simplified form which will be elaborated upon below in the Detailed Description. This Summary is not intended to identify essential features of the claimed subject matter, nor is it intended to be used to limit the scope for the claimed subject matter.

Disclosed is a drive unit of a powered wheel for a wheelchair, the drive unit comprising: a battery for powering the drive unit; an electric motor for driving the powered wheel; and at least one retractable locking pin for engaging the drive unit with the wheelchair to allow the electric motor to drive the wheelchair.

In one embodiment the at least one retractable locking pin engages with a locking pin receiver of an integration bracket mounted on the wheelchair.

In one embodiment the at least one locking pin can be disengaged from the locking pin receiver of the integration bracket to place the powered wheel in a free wheel mode.

In one embodiment the at least one locking pin is disengaged from the pin receiver by a locking mechanism located on a hub of the powered wheel.

In one embodiment the locking mechanism is rotated to engage the locking pin with the locking pin receiver of the integration bracket.

In one embodiment the drive unit further comprises: a location sensor for determining which side of the wheelchair the powered wheel is mounted.

In one embodiment the location sensor is a hall sensor. Alternatively the location sensor detects a location identifier attached to the wheelchair.

In one embodiment the location identifier is formed as part of an integration bracket mounted on the wheelchair. In one embodiment the integration bracket includes a magnet as the location identifier.

In one embodiment the battery is a removable battery.

In one embodiment the electric motor is connected to an output drive sprocket using a plurality of belts.

In one embodiment the drive unit is fitted to a wheel for a wheelchair fitted.

Disclosed is a method of converting a powered wheel of a wheelchair from a freewheel mode to a powered mode, the method comprising: releasing a locking pin on the powered wheel from the freewheel mode position; receiving a command to start a wheel lock mode for the powered wheel; rotating a hub of the powered wheel relative to a wheel of the powered wheel; and determining that the locking pin of the powered wheel is captured by a locking pin receiver on an integration bracket on the wheelchair to enable to powered wheel to move the wheelchair in powered mode.

In one embodiment, determining that the locking pin is captured by the locking pin receiver is determined based on torque applied to a motor of the powered wheel and a position of the powered wheel.

In one embodiment, the locking pin is spring loaded to enter the locking pin receiver.

In one embodiment, the integration bracket depresses the locking pin to allow the locking pin to slide over the integration bracket.

In one embodiment, rotating the hub has a predetermined number of rotations before timing out.

Also disclosed is a method of removing a bung from a socket, the method comprising: placing a surface of a cap on an exposed surface of the bung, the surface of the cap being a mating surface that conforms to the exposed surface of the bung, wherein the cap is used to seal a plug adapted to connect with the socket; aligning at least one magnet in the bung with at least one magnet in the cap; and moving the cap away from the socket to remove the bung from the socket.

In one embodiment, the at least one magnet in the bung is two magnets and the at least one magnet in the cap is two magnets.

In one embodiment, an alignment mark on the cap is aligned with an alignment mark on the bung.

In one embodiment, magnetic attraction of the at least one magnet in the cap is stronger than magnetic attraction between the at least one magnet of the bung and the socket.

Also disclosed is a method of controlling at least one powered wheel of a wheelchair, the method comprising: estimating a pose contribution for motor power consumption; estimating a surface contribution for motor power consumption; determining a user interaction from the estimated pose contribution and the estimated surface contribution and motor data for the at least one powered wheel; and modifying operation of a motor of the powered wheel according to the determined user interaction to control the at least one powered wheel.

In one embodiment, estimating the surface contribution includes estimating a surface type on which the at least powered wheel operates.

In one embodiment, the surface type determines an estimated change in power consumption for the motor.

In one embodiment, determining the user interaction also includes a motion contribution from acceleration of the wheelchair.

In one embodiment, determining the user interaction attributes a discrepancy between expected power used by the motor and actual power used by the motor.

In one embodiment, wherein the expected power used by the motor is determined using the estimated pose contribution and the estimated surface contribution.

### BRIEF DESCRIPTION OF FIGURES

At least one embodiment of the present invention is described, by way of example only, with reference to the accompanying figures.

FIG. 1 illustrates powered wheel according to one embodiment;

FIG. 2 illustrates an alternative powered wheel according to one embodiment;

FIGS. 3A and 3B illustrate an alternative powered wheel according to one embodiment;

FIG. 4 illustrates a cutaway of a drive unit of a powered wheel according to one embodiment;

FIG. 5 illustrates an alternative cutaway view of the drive unit of FIG. 4;

FIG. 6 illustrates a rear view of the drive unit of FIG. 4;

FIG. 7 illustrates a remote control used to control one or more powered wheels according to one embodiment;

FIGS. 8A and 8B each illustrate a base for the remote control;

FIGS. 9A and 9B illustrate a left and right integration bracket for a powered wheel according to one embodiment;

FIGS. 10A, 10B and 10C illustrate powered wheels according to one embodiment;

FIG. 11 illustrates an alternative view of a powered wheel according to one embodiment;

FIG. 12 illustrates a wheelchair fitted with powered wheels according to one embodiment;

FIG. 13A illustrates a removable battery for use in a powered wheel;

FIG. 13B illustrates an external battery charger for the battery of FIG. 13A;

FIGS. 14A and 14B illustrate views of a carry case for the powered wheels according to one embodiment;

FIGS. 15A and 15B illustrate an internal view of the carry case of FIGS. 14A and 14B;

FIGS. 16A, 16B and 16C illustrate a user interface for connecting to a powered wheel according to one embodiment;

FIG. 17A illustrates a powered wheel according to one embodiment;

FIG. 17B illustrates an integration bracket for the powered wheel of FIG. 8A;

FIGS. 18A and 18B illustrate a plug and socket for use with the powered wheel of FIG. 17A;

FIG. 19 illustrates a bung according to one embodiment;

FIGS. 20A and 20B illustrate the bung of FIG. 19 inserted into a socket;

FIGS. 21A and 21B illustrate a bottom view and cross section of the bung of FIG. 19;

FIGS. 22A and 22B illustrate a cap according to one embodiment;

FIG. 22C illustrates a cross section of a cap end of the cap of FIGS. 22A and 22B;

FIG. 23 illustrates the cap of FIGS. 22A and 22B as used on a cable with a plug;

FIG. 24 illustrates a control system for controlling a powered wheel according to one embodiment;

FIG. 25 illustrates an automated locking pin process according to one embodiment;

FIG. 26 illustrates a bung removal process according to one embodiment; and

FIG. 27 illustrates a powered wheel control process according to one embodiment.

### DETAILED DESCRIPTIONS

The following description, given by way of example only, is described in order to provide a more precise understanding of one or more of the embodiments. In the figures, like reference numerals are used to identify like parts throughout the figures.

Disclosed is a powered wheel that may be attached to a wheelchair to allow the wheelchair to operate as an electric wheelchair with part or all of the driving force provided by an electric motor in the wheel. The powered wheels replace the non-caster wheels of the wheelchair. Each powered wheel is self-contained with a battery, motor, motor controller and drive system forming part of the wheel. Two powered wheels fitted to a wheelchair may be the same and use sensor input to the motor controller to determine if the wheel is mounted on a left or right side of the wheelchair. The powered wheel equipped wheelchair may then be controlled by a remote control unit or by physically interacting with the powered wheels using hand rims on the powered wheels. The force applied to the powered wheels by the wheelchair user is detected by the motor controller and output of the motor adjusted to allow the powered wheels to respond to the interaction by the wheelchair user.

The powered wheel has a drive unit that comprises a battery for powering the drive unit. The drive unit also comprises an electric motor for driving the powered wheel as well as at least one retractable locking pin for engaging the drive unit with the wheelchair to allow the electric motor to drive the wheelchair.

Also disclosed is a method of converting an intelligent powered wheel of a wheelchair from a freewheel mode to a powered mode. The method includes releasing a locking pin on the powered wheel from the freewheel mode position to a powered mode. The locking pin is in a position ready to be engaged with an integration bracket on the wheelchair. A command is received to start a wheel lock mode for the powered wheel. A hub of the powered wheel rotates, relative to a wheel of the powered wheel and is captured, or engaged, by a receiver in the integration bracket. The method determines that the locking pin of the powered wheel is captured by a locking pin receiver on an integration bracket on the wheelchair to enable to powered wheel to move the wheelchair in powered mode.

Also disclosed is a method of removing a bung from a socket using a matching cap that is designed to fit on a plug for the socket. The method includes placing a surface of the cap on an exposed surface of the bung, the surface of the cap being a mating surface that conforms to the exposed surface of the bung, wherein the cap is used to seal a plug adapted to connect with the socket. The cap and the bung are aligned to align at least one magnet in the bung with at least one magnet in the cap. Pulling, or moving, the cap away from the socket removes the bung from the socket.

Also disclosed is a method of controlling at least one powered wheel of a wheelchair. The method includes estimating a pose contribution for motor power consumption as well as estimating a surface contribution for motor power consumption. A user interaction is determined from the estimated pose contribution and the estimated surface contribution as well as motor data for the at least one powered wheel. The operation of the motor of the powered wheel is modified according to the determined user interaction to control the at least one powered wheel.

### Example Powered Wheels

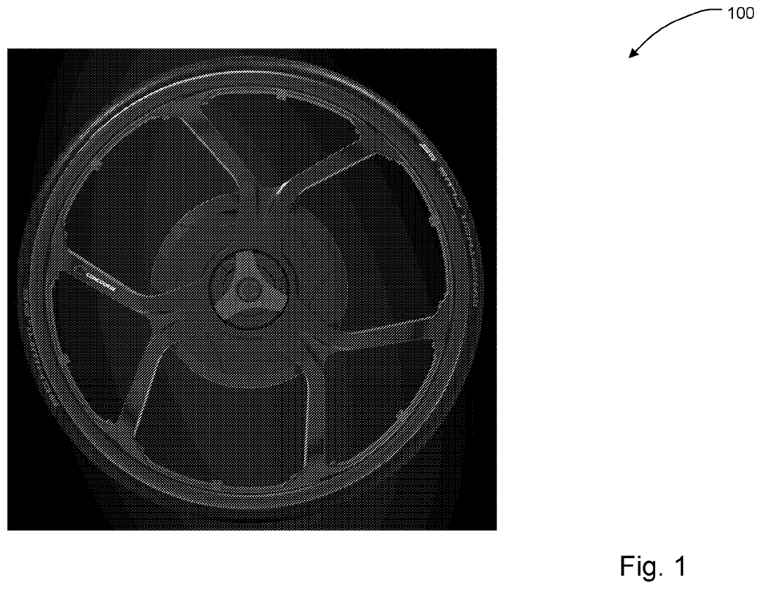

FIG. 1 shows a powered wheel 100 that may be attached to a wheelchair. The powered wheel 100 is typical a 16 inch wheelchair size wheel for non-caster wheelchair wheels. Once two of the powered wheels are attached to the wheelchair, controllers in each of the powered wheels may communicate wirelessly to allow the powered wheels to operate together and allow co-ordinated operation of the powered wheels. Each of the powered wheels communicate to the other powered wheel using a wireless data connection, such as Bluetooth or wireless Ethernet. The data connection between the powered wheels allows the speed of the wheels to be co-ordinated.

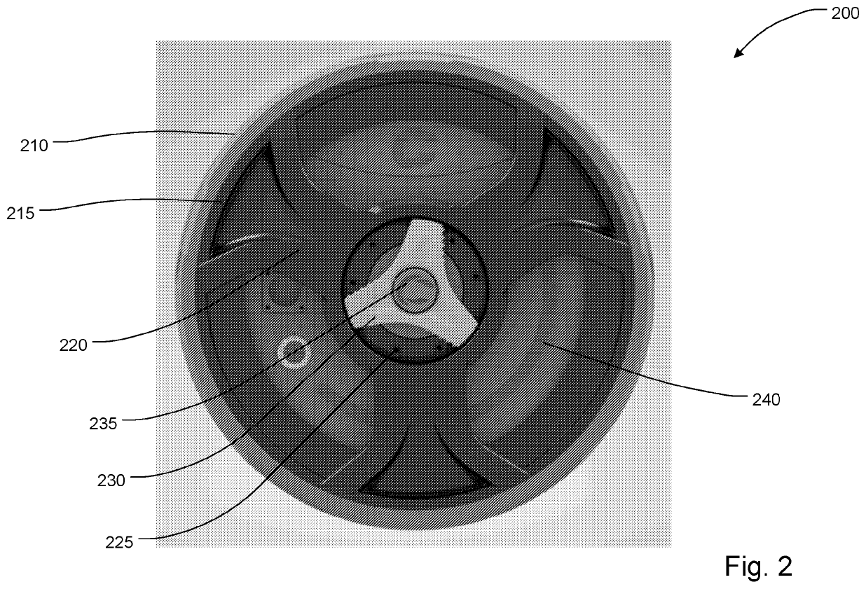

FIG. 2 shows a powered wheel 200 that may be used as a wheel of a wheelchair. The powered wheel 200 is a smaller sized 12 inch sized non-caster wheel. The powered wheel 200 has a tyre 210 mounted to a rim 215 with three spokes 220 connecting and supporting the rim 215 from a hub 225. Located at the hub 225 is a locking mechanism 230 used to engage and disengage locking pins to convert the powered wheel 200 from a motor driven wheel to a fully manual wheel. The locking mechanism 230 is rotated to change the locking pin engagement. When the powered wheel 200 is mounted to a wheelchair, the locking mechanism 230 is turned in a first direction to engage the locking pins and in an opposite direction to disengage the locking pins. An axle pin 235 is located at the centre of the locking mechanism 230. The axle pin is for a quick release wheelchair half inch axle

A drive unit 240 is located on the inside of the powered wheel 200. When mounted to a wheelchair, the drive unit 240 is located between the powered wheel 200 and the wheelchair. Details of the drive unit 240 will be described in more detail below.

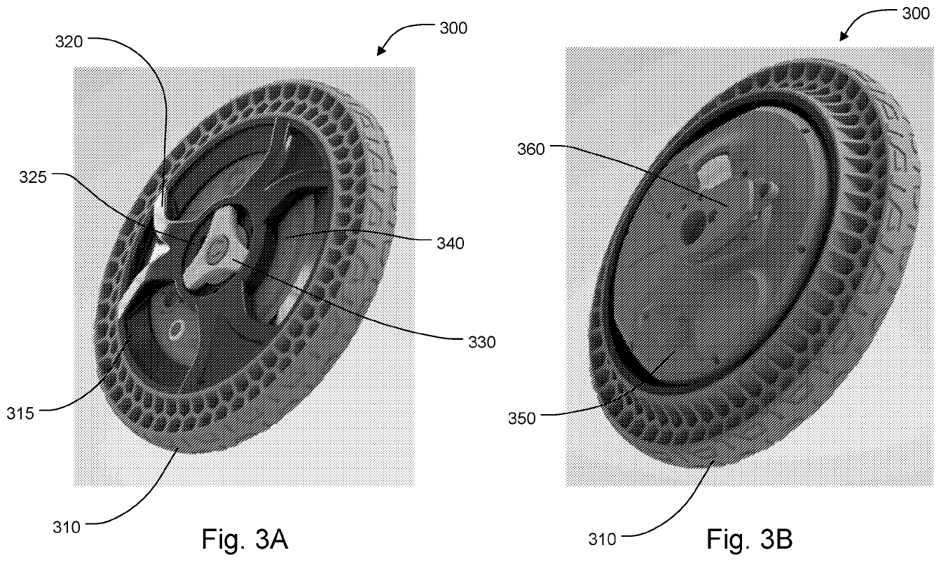

FIGS. 3A and 3B show an alternative 16 inch powered wheel 300 that is similar to the powered wheel 200 described above. FIG. 3A shows an outside view of the powered wheel 300 while FIG. 3B shows an inside view of the powered wheel 300.

The powered wheel 300 has an airless tyre 310 mounted on a rim 315. Spokes 320 connect the rim 315 to a hub 325 which has a locking mechanism 330 that operates in the same manner as the locking mechanism 230 to engage and disengage locking pins. A drive unit 340 is located on the inside of the powered wheel 300. A rear side 350 of the drive unit 340 is visible in FIG. 3B with an integration bracket 360. The integration bracket 360 will be described in more detail below.

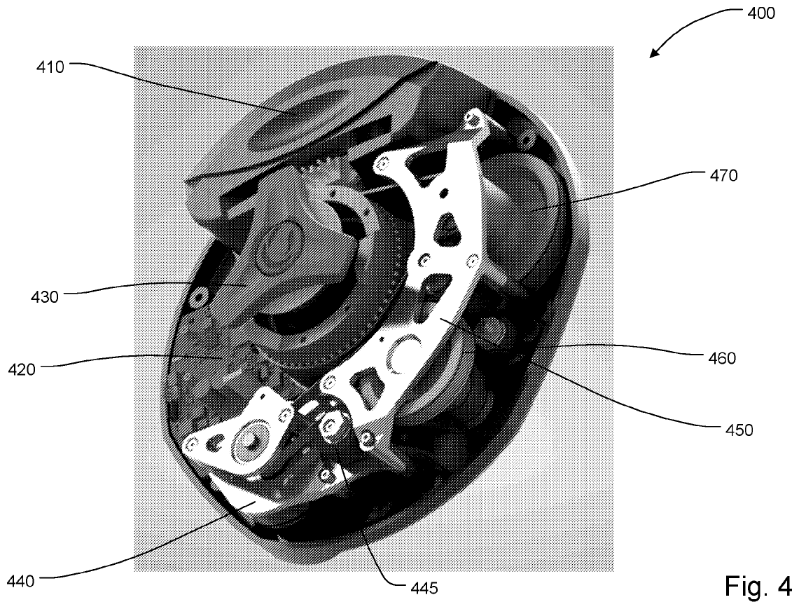

FIGS. 4 and 5 show cutaway views of a drive unit 400 which may be the drive unit 240 of FIG. 2 or the drive unit 340 of FIG. 3. The drive unit 400 shows an arrangement of a number of components used to drive a powered wheel. The drive unit 400 is attached to the powered wheel and includes a locking mechanism 430 that engages and disengages a locking pin of the drive unit 400 to an integration bracket mounted to the wheelchair.

The drive unit 400 has a removable battery 410 arranged at the top of the drive unit 400. The removable battery 410 is latched in place and a physical button or switch is operated to remove the battery. Use of a removable battery allows for spare batteries to be swapped into a powered wheel as required. Located below the removable battery 410 is a drive controller 420 which is a printed circuit board containing the required electronic and electrical controls. The drive controller 420 connects to the removable battery 410 using one or more connectors to the printed circuit board. A microprocessor, mounted on the printed circuit board, operates a motor controller connected to an electric motor 440. The drive controller 420 also contains a wireless communications controller that attaches to an antenna. The wireless communications controller may be configured to communicate to other powered wheels attached to a wheelchair as well as to a remote control that will be described in more detail below.

The drive controller 420 may also contain a one or more position sensors which may be a combination of a 3-axis gyroscope, 3-axis accelerometer, 3-axis magnetometer, Hall Effect sensors and global positioning system. The use of one or more of the position sensors, combined with information from the electric motor, allows the drive controller 420 to determine a rotational speed and linear direction and speed of the powered wheel. By monitoring individual wheel position sensor information, and comparing sensor information from a left hand side powered wheel of a wheelchair to the sensor information from a right hand side powered wheel it is possible for the drive controller 420 to determine motion of the wheelchair. For example, the drive controller 420 of the left hand side and right hand side powered wheels communicate over a wireless network to share information. Using the 3-axis gyroscope, 3-axis accelerometer and 3-axis magnetometer, allows the drive controller 420 to determine if the wheelchair is on a slope and which way the wheelchair is facing on the slope and/or to determine if the wheelchair is moving in a straight line. Determining such information allows the drive controller 420 to drive the wheelchair in a straight line along a slope by adjusting power delivered to the left and right hand side powered wheels on the wheelchair.

The use of the sensors, combined with information from the electric motor and active torque limiting of the motor, allows for the wheelchair to operate in a manual steering mode while using a set of powered wheels in a powered mode. As the wheelchair is driven by the powered wheels with a torque limit applied, the user may grab one of the powered wheels to slow down the wheel. The increase in torque demand from the motor is detected and/or a change in direction of the wheelchair. The sensor and motor information is combined to determine that the user is turning the wheelchair. The drive controllers of the two powered wheels communicate to allow the wheelchair to change direction. Such an arrangement allows a wheelchair equipped with powered wheels to move in a straight line, even when operating on a slope, as well as allow manual steering via user interaction with the powered wheels. The straight line operation occurs even though the left and the right side power wheels are not physically connected with communication wires.

The sensors may also allow the drive unit 400 to determine a speed of the wheelchair and apply motor braking to prevent over speeding as the wheelchair travels down a slope. Motor braking may also be used to provide a park brake function on a hill by use of the position sensors detecting motion of the wheelchair and using the motors to prevent movement of the wheelchair.

The electric motor 440 is arranged to provide drive for the powered wheel through a series of belts. There are three belts arranged between the electric motor 440 and an output drive sprocket 490. A first belt is connected between the electric motor 440 and a primary stepped sprocket 460 with a tension sprocket 445 maintaining a suitable tension on the first belt. The electric motor 440 is tensioned using a sliding motor that provides suitable tension that may reduce friction and noise on the fastest moving belt of the drive unit 400. A second belt runs between the primary stepped sprocket 460 and a secondary stepped sprocket 470. A toothed belt 480 runs between the secondary stepped sprocket 470 and the output drive sprocket 490. The shaft speed of the electric motor 440 is reduced using first, second and toothed belts to a final output speed. The toothed belt 480 is used for the final stage of the drive due to the amount of torque required to turn the powered wheel. Shafts, extending from one end of the primary stepped sprocket 460 and the secondary stepped sprocket 470, are held in in place by a support bracket 450.

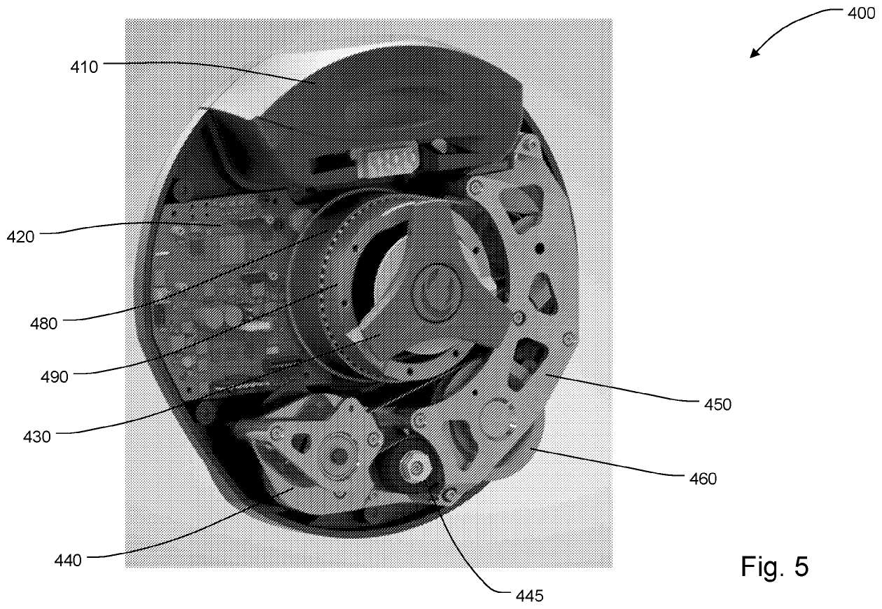

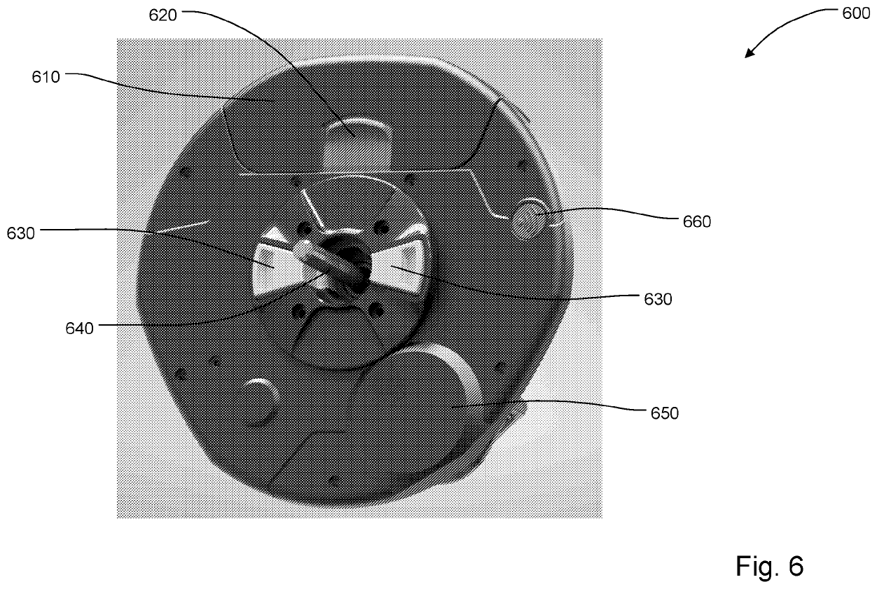

FIG. 6 shows a rear side of a drive unit 600 in more detail. The drive unit shown in FIG. 6 is a drive unit such as the drive unit 400 of FIG. 4. The drive unit 600 has a removable battery 610 with a battery release 620. The battery release 620 allows the removable battery 610 to be removed from the drive unit 600 to swap or replace the removable battery 610.

Locking pins 630 are located on either side of an axle 640, which may be a standard quick release wheelchair half inch axle. The locking pins 630 engage with a corresponding locking pin receiver in an integration bracket fitted to the wheelchair. When one of the locking pins 630 engage with the locking pin receiver the locking pin prevents the drive unit 600 from rotating. Rotationally fixing the drive unit 600 allows the powered wheel to rotate about the drive unit 600 to drive the wheelchair. Disengaging the locking pins 630 places the powered wheel in a freewheel mode where the motor of the drive unit 600 is disengaged allowing the user of the wheelchair to operate the wheelchair manually without any assistance or resistance from the motor. When in freewheel mode, the spring-loaded locking pin retracts allowing the drive unit to rotate along with the powered wheel.

A motor protrusion 650 is formed in the drive unit 600 to provide sufficient room for an electric motor in the drive unit 600. Finally, an antenna 660 is located on the drive unit 600. The antenna 660 is connected to the drive controller to allow the drive controller to wirelessly communicate with other powered wheels and/or a remote controller.

### Remote Control

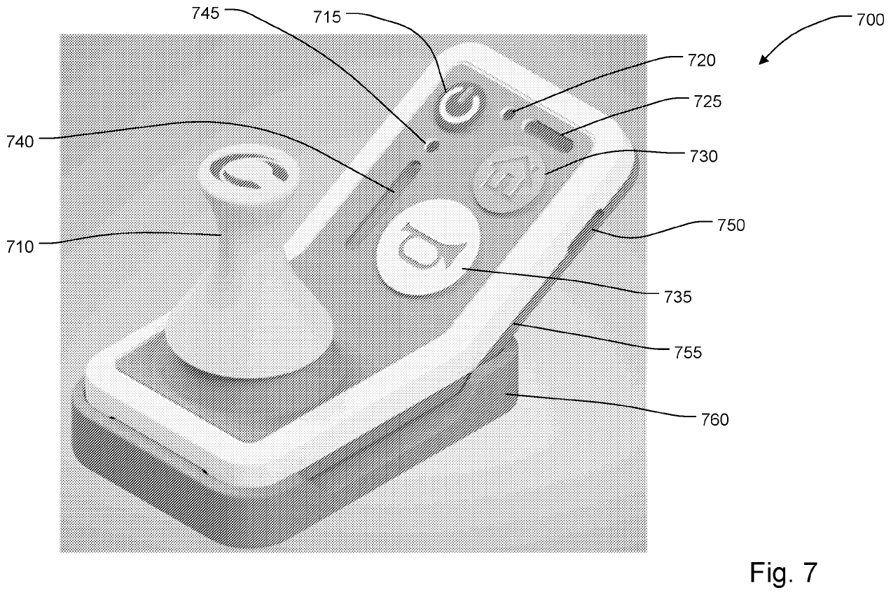

FIG. 7 shows a remote control 700 that may be used to control a wheelchair fitted with powered wheels, such as the powered wheel 100 described above. The powered wheels are wirelessly linked to and controlled by the remote control 700. A wheelchair user, or someone else with the remote control 700 within wireless communication range of the powered wheels, can control the wheelchair fitted with the powered wheels. Typically the wireless control link may be a Bluetooth connection, such as Bluetooth 5.0, although other wireless data connections may also be used to control the wheels from the remote control 700. The remote control 700 may be used to control the wheelchair when the wheelchair is operating in remote control mode or to select a complete manual control mode where the wheelchair user operates the wheelchair by interacting with the wheels and the motors of the powered wheels are disengaged.

The remote control 700 has a joystick 710 that a user can manipulate to move the wheelchair. The joystick 710 is moved along a first axis, forward and backwards, to move the wheelchair forwards and backwards, and along a second axis, left and right, to turn the wheelchair left or right. The joystick 710 may also have additional control features. For example, pressing the top of the joystick 710 may change the operational mode of the wheelchair and toggle between one or more modes for the powered wheels. In one example, pressing the joystick 710 may switch the powered wheels between a joystick control operational mode where manual interaction with the wheels is disabled and the control of the wheelchair is performed only using the joystick 710. Pressing the top of the joystick 710 may enable the operation of powered manual control of the wheelchair by physical interaction with the wheels. The operational mode of the wheelchair is indicated by the operational mode indicator 725.

The remote control 700 has a power button 715 to power up the remote control 700 and connect to the powered wheels. In one embodiment, the power button 715 may be used to turn off the powered wheels or put the powered wheels into a standby mode by pressing and holding the power button 715. If the powered wheels are powered off they can be powered on using a power button located on the drive unit of each powered wheel.

A power indicator 745 shows the battery level for the remote control 700. Below the power indicator 745 is a battery level indicator 740 showing the power level for the powered wheels by displaying the battery level for the powered wheel with the lowest battery power. The battery level indicator 740 may use a full to empty style battery gauge.

An audible warning button 735 may be pressed to produce an audible warning to alert those nearby to the presence of the wheelchair. A speed limiter button 730 may be used to toggle a speed limiting function for the powered wheels. For example, when the wheelchair is used inside, the wheelchair user may select to speed limit the wheelchair and then disable the speed limiting function outside.

The remote control 700 is powered by a battery which may be charged by a charging port 750. The charging port 750 can accept a standard USB-C type connector with power delivered using power delivery options as found on mobile phones, such as power delivery or Quick Charge developed by Qualcomm.

The remote control 700 as shown in FIG. 7 has two parts. A removable controller 755 and a base 760. The removable controller 755 is attached to the base unit 760 with a release button to prevent the removable controller 755 from being accidentally knocked off the base unit 760. The removable controller 755 may be attached to the leg mounted base attached to the wheelchair user with a leg strap. Alternatively, the removable controller 755 may be used while attached to the base unit 760. Another option is that the base unit 760 may be permanently mounted to an arm of the wheelchair.

A light sensor 720 detects the amount of ambient light and adjusts brightness of any indicators, such as the battery level indicator 740 and the power indicator 745 of the remote control 700.

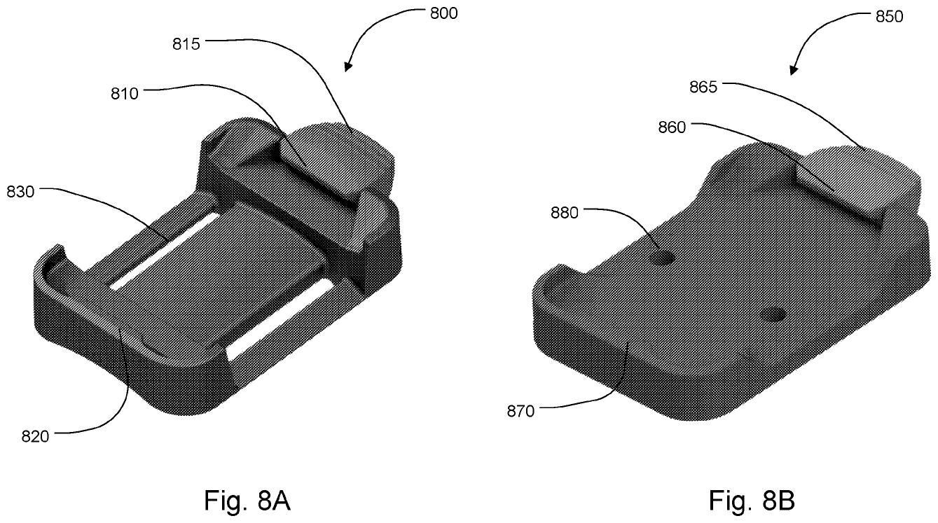

FIG. 8A shows a leg mounted base 800 that may be used with the remote control 700 of FIG. 7. The leg mounted base 800 allows a removable controller to clip into the base. A retaining tab 820 fits into a corresponding socket on the removable controller and a releasable retaining tab 810 fits into a corresponding socket on an opposite end of the removable controller. The removable controller is released by pressing a release button 815 to remove the releasable retaining tab 810.

The leg mounted base 800 is attached to a leg of the user using a belt. The belt is threaded through leg strap mounts 830 to press the leg mounted base 800 to a leg of the user.

FIG. 8B shows a screw mounted base 850 that operates in a similar manner to the leg mounted base 800. The screw mounted base 850 has a retaining tab 870 and a releasable retaining tab 860. The releasable retaining tab 860 can be removed from the removable controller using a release button 865. The screw mounted base 850 may be attached to a suitable surface, such as an arm of a wheelchair, using screws that pass through recessed screw holes 880.

### Example Integration Bracket

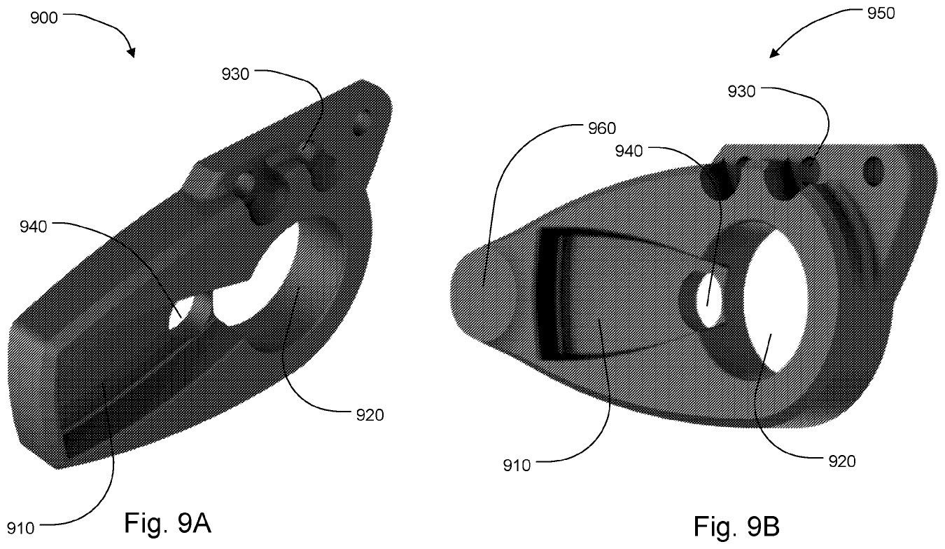

FIGS. 9A and 9B show a left integration bracket 900 and a right integration bracket 950 respectively. The integration brackets are mounted to a wheelchair to allow the wheelchair to use powered wheels. There may be no need to replace camber bars on the wheelchair or for additional modification to the wheelchair other than installing the integration brackets. The integration brackets can be adapted to suit different wheelchair types from different manufacturers and provide a mechanical interface between the wheelchair and a powered wheel.

The left integration bracket 900 is mounted on a left hand side of a wheelchair. While the powered wheels for a wheelchair are the same for the left hand side and the right hand side, and can be swapped between sides, the integration brackets differ between sides so that the powered wheels can determine which side of the wheelchair they are mounted on. The left integration bracket 900 has a locking pin receiver 910 for receiving a locking pin, such as the locking pins 630 described in relation to the drive unit 600 of FIG. 6. Only one of the two locking pins 630 is captured by the locking pin receiver 910. An axle shaft 920 allows an axle to pass through the left integration bracket 900. The left integration bracket 900 is attached to the chair using screw or bolts that pass through mounting holes 930. An aperture 940 is located within the locking pin receiver 910 to provide clearance for parts on the wheelchair, such as a screw head.

The right integration bracket 950 is shown in FIG. 9B. Most features of the right integration bracket 950 match the features of the left integration bracket 900. One difference between the left integration bracket 900 and the right integration bracket 950 is a magnet 960 located within the right integration bracket 950 operating as a location identifier. The magnet 960 may be detected by a location sensor on a drive unit and allow the drive unit to determine that the powered wheel is on a right hand side of the wheelchair. The magnet 960 is detected by a location sensor in the drive unit. An example of a location sensor is a Hall sensor which detects the presence and magnitude of a magnetic field using the Hall Effect. The drive units attached to the wheelchair communicate and use readings from the Hall sensor in the left powered wheel and the right powered wheel. Checks are made to ensure that only one powered wheel can detect the location identifier. If each wheel detects the magnet then a fault occurs. Similarly if no magnets are detected the drive units of the powered wheels will detect the arrangement as faulty. For correct operation only one powered wheel should detect the location indicator and that wheel is the assigned to operate as the right powered wheel.

The integration brackets may be manufactured out of glass filled nylon using a 3D printer. Such a manufacturing approach allows for easy customization, ease of manufacturing, light weight, high strength and high durability. The use of a 3D printer also allows cost effective customization of integration brackets for different wheelchairs.

### Further Powered Wheel Examples

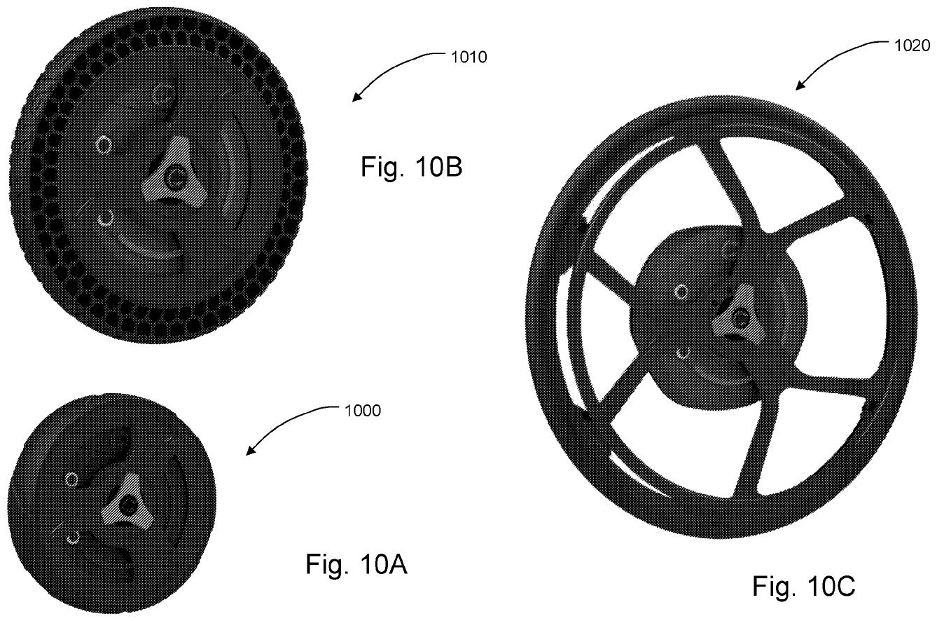

FIGS. 10A, 10B and 10C show different sized powered wheels that may be used on wheelchairs. FIG. 10A shows a powered wheel 1000 which is a 12 inch wheel with a drive unit fitting inside. FIG. 10B shows a powered wheel 1010 which is 16 inches in size, while FIG. 10C shows a powered wheel 1020 with wheel size of 24 inches.

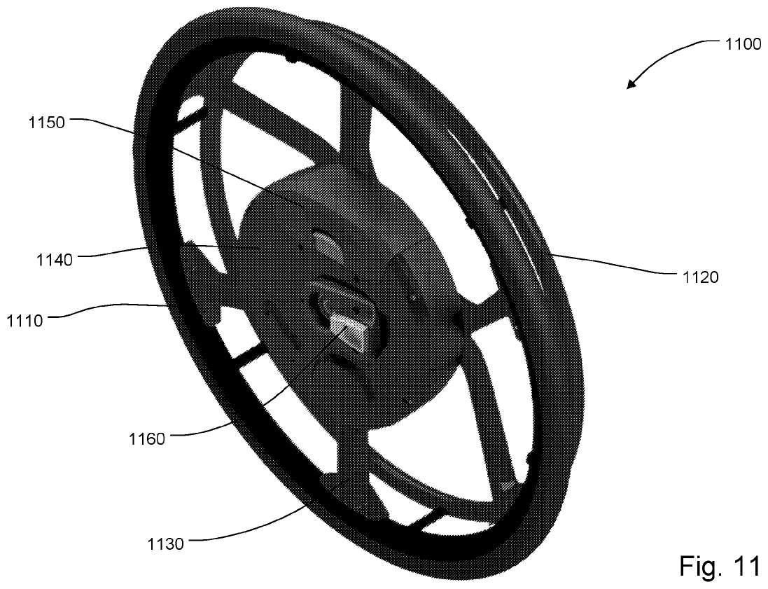

FIG. 11 shows a powered wheel 1100, such as the powered wheel 1020 of FIG. 10C. The side of the wheel shown in FIG. 11 faces the wheelchair when mounted on the wheelchair. The powered wheel 1100 has a tyre 1110 and rim, supported by spokes 1130. A hand rim 1120 is also attached to the powered wheel 1100.

A drive unit 1140 has a removable battery 1150 as well as a locking pin 1160. Unlike the powered wheels discussed earlier, the powered wheel 1100 has a single locking pin 1160 instead of dual locking pins.

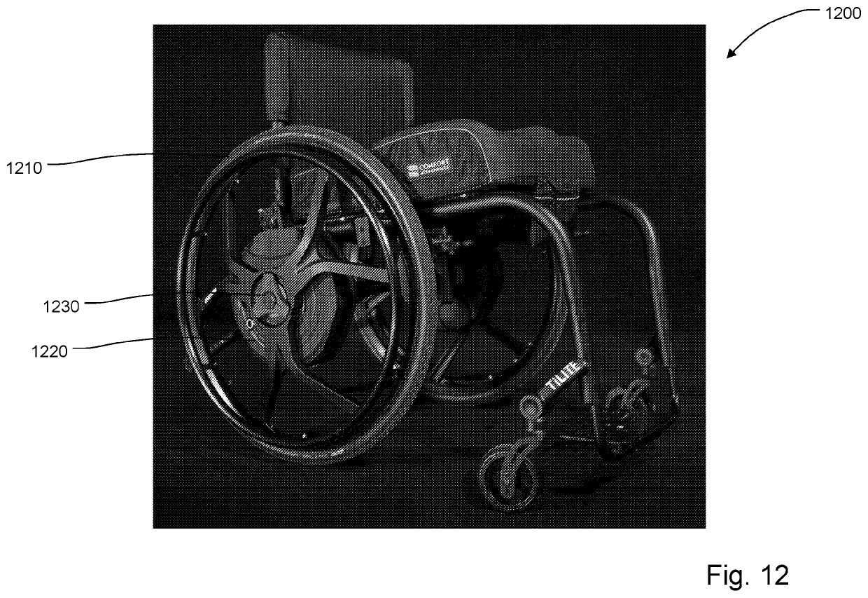

A wheelchair 1200 is shown in FIG. 12. The wheelchair 1200 has integration brackets attached to allow powered wheels 1210 to be attached. The powered wheels 1210 are typically a 16 inch wheelchair size wheel for non-caster wheelchair wheels. Once two of the powered wheels are attached to the wheelchair, controllers in each of the powered wheels may communicate wirelessly to allow the powered wheels to operate together and allow co-ordinated operation of the powered wheels. Each of the powered wheels communicate to the other powered wheel using a wireless data connection, such as Bluetooth or wireless Ethernet. The data connection between the powered wheels allows the speed of the wheels to be co-ordinated. Each of the powered wheels 1210 has a drive unit 1220 and a locking mechanism 1230 that operates in a similar manner to the locking mechanism 230 of FIG. 2.

### Battery Pack

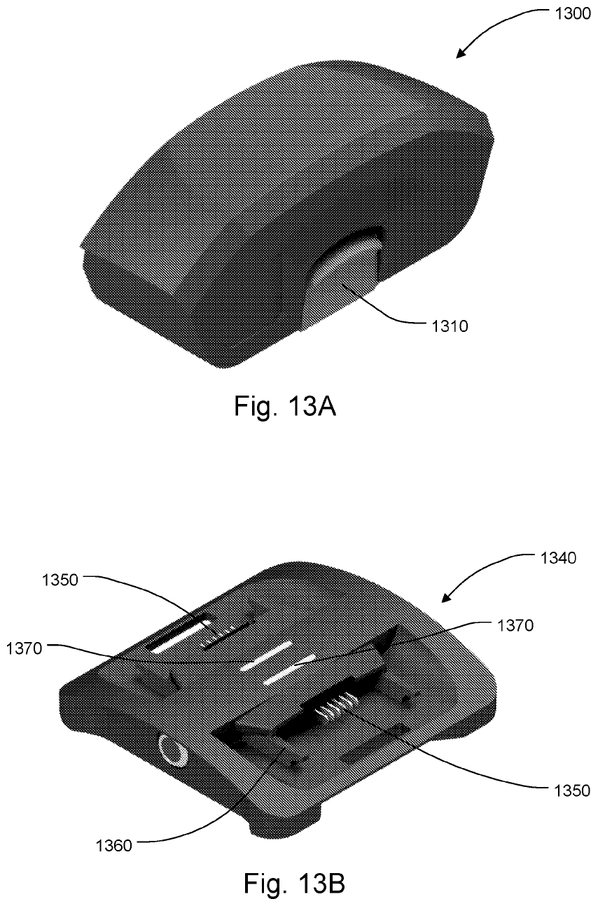

More details of the removable battery of a drive unit will now be described with reference to FIGS. 13A and 13B. FIG. 13A shows a removable battery 1300 as used with a drive unit, such as the drive unit 400. The removable battery 1300 has a battery release 1310 which is pressed to release the battery. The removable battery 1300 may be a 24V, 4 Ah, 96 Wh Li-ion battery that mounts directly on the drive unit to provide approximately 15 km of travel. The removable battery 1300 is designed to be multidirectional, so that the removable battery 1300 can be connected to the drive unit with the battery release 1310 facing away from or towards the wheelchair when the powered wheel is mounted to a wheelchair. Spokes of the powered wheel are arranged to provide clearance for the battery release 1310 to be installed or removed from the powered wheel while mounted on a wheelchair.

Charging the removable battery 1300 may be done either when the removable battery 1300 is installed in a drive unit or using an external battery charger 1340. The removable battery 1300 may be charged by connecting a power source to the drive unit the removable battery 1300 is installed on. The external battery charger 1340 allows the user to charge the removable battery 1300 when disconnected from the powered wheel. The removable battery 1300 charger can operate with input voltage of 100-240V AC at 50/60 Hz making the external battery charger 1340 safe for use in different countries. The removable battery 1300 may take approx. 4hrs to receive a full charge.

The external battery charger 1340 has pins 1350 that electrically connect to corresponding connectors on the removable battery 1300. Alignment tabs 1360 mechanically connect the removable battery 1300 to the external battery charger 1340. The external battery charger 1340 can charge up to two removable batteries at the same time and has status indicators 1370 to show the charge state for each removable battery. The status indicators 1370 show a red light to indicate that the battery is charging and a green light to indicate that the battery has charged.

### Powered Wheel Carry Case

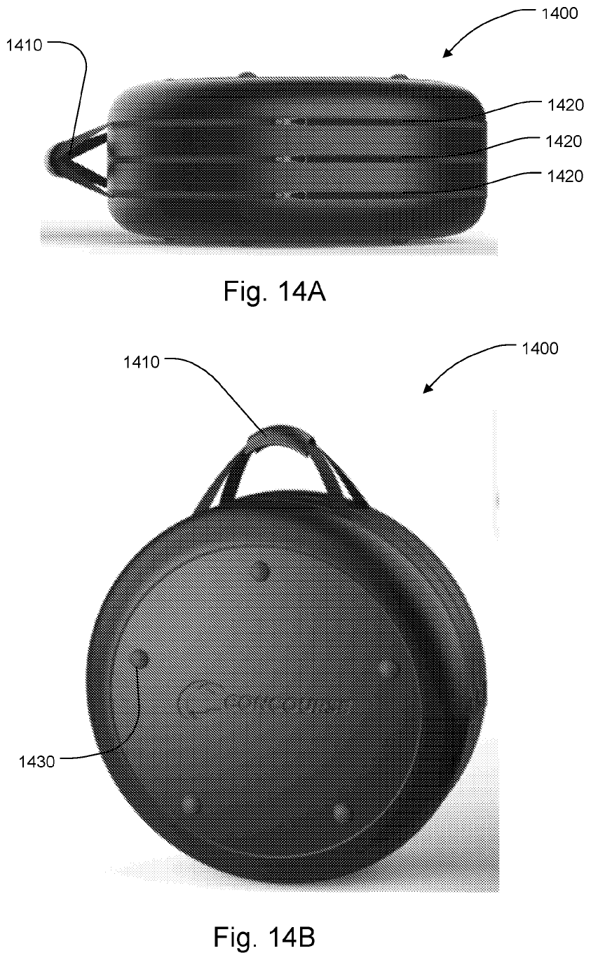

A carry case 1400 will now be described with reference to FIGS. 14A and 14B. The carry case 1400 can be used to carry a pair of powered wheels as well as additional equipment such as spare batteries and chargers. The carry case 1400 has a handle 1410 and is divided into multiple compartments that are accessible using zippers 1420. The carry case 1400 sits on feet 1430.

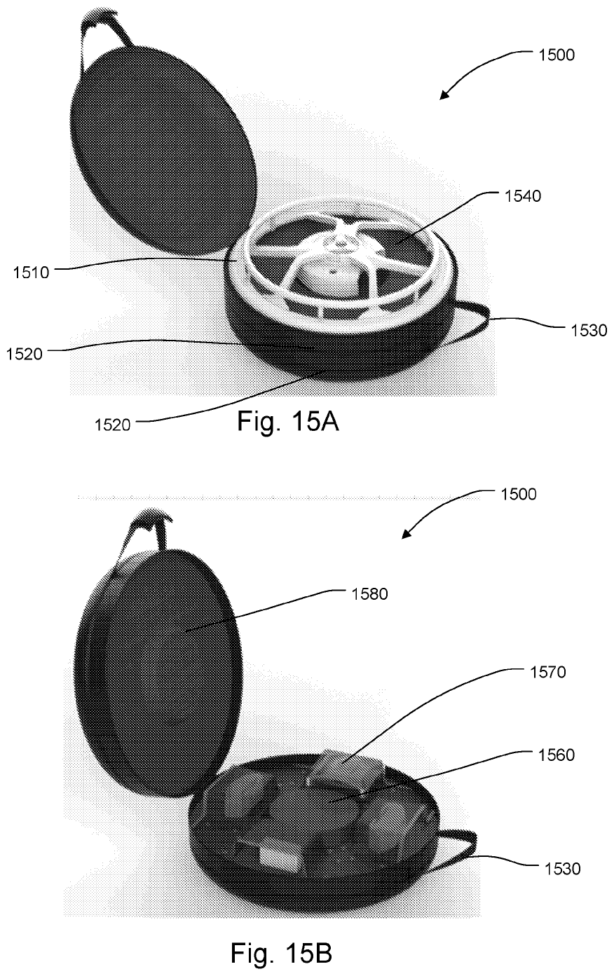

FIGS. 15A and 15B show a carry case 1500, such as the carry case 1400 of FIGS. 14A and 14B. The carry case 1500 is open to show a first compartment 1540 in FIG. 15A. The first compartment 1540 holds a powered wheel 1510. The outside of the carry case 1500 has zippers 1520 for accessing other compartments along with a handle 1530 for transporting the carry case 1500. FIG. 15B shows the carry case 1500 open at a second compartment 1560. The second compartment 1560 holds accessories for the powered wheel 1510, such as a spare battery 1570 or other items such as a battery charger. A base 1580 of the first compartment 1540 can also be seen in FIG. 15B.

### Powered Wheel Configuration

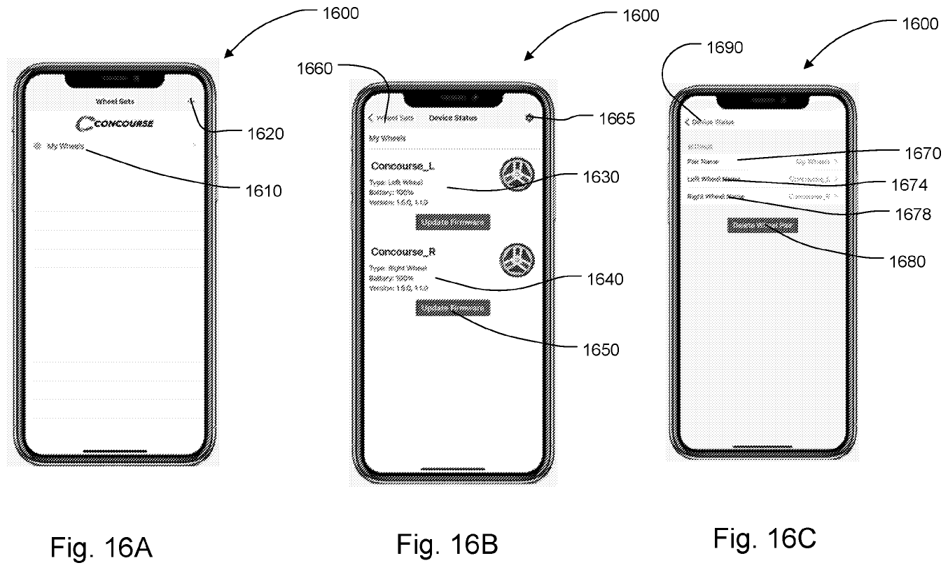

FIGS. 16A, 16B and 16C show a mobile phone based application for connecting to powered wheels. Each of the figures shows a mobile phone 1600 with three different displays of the application. FIG. 16A shows a top level of the application with a list of configured devices 1610 connected to the application. Adding new devices, such as an additional powered wheel, is done by pressing an add device button 1620.

FIG. 16B shows device status information when the configured devices 1610 is selected. Two powered wheels are shown, with a left connected wheel 1630 and a right connected wheel 1640. Status information is displayed for each of the connected wheels. The status information may include battery charge information, firmware version for the drive unit, estimated distance on the remaining charge and time left until fully charged if the battery is charging while connected to the drive unit. Updates to firmware for the drive unit of the powered wheels may be carried out by pressing drive unit controller firmware update button 1650 to deliver firmware updates over the air. Both the left connected wheel 1630 and the right connected wheel 1640 may be updated separately. To return to the top level, shown in FIG. 16A, the user presses a return button 1660.

FIG. 16C shows the display when a settings button 1665 in FIG. 16B is pressed. The setting display shows a change wheel pair name button 1670, a change left wheel name button 1674 and a change right wheel name button 1678. Changing the name of the wheels allows a user to enter customised names for each wheel as well as for the set of powered wheels. This may be helpful for users with more than one wheelset. As well as changing names, the display has a delete wheel pair button 1680 to remove the wheels from the application. Pressing a return to device status 1690 will return the application to the display of FIG. 16B.

### Additional Powered Wheel Examples

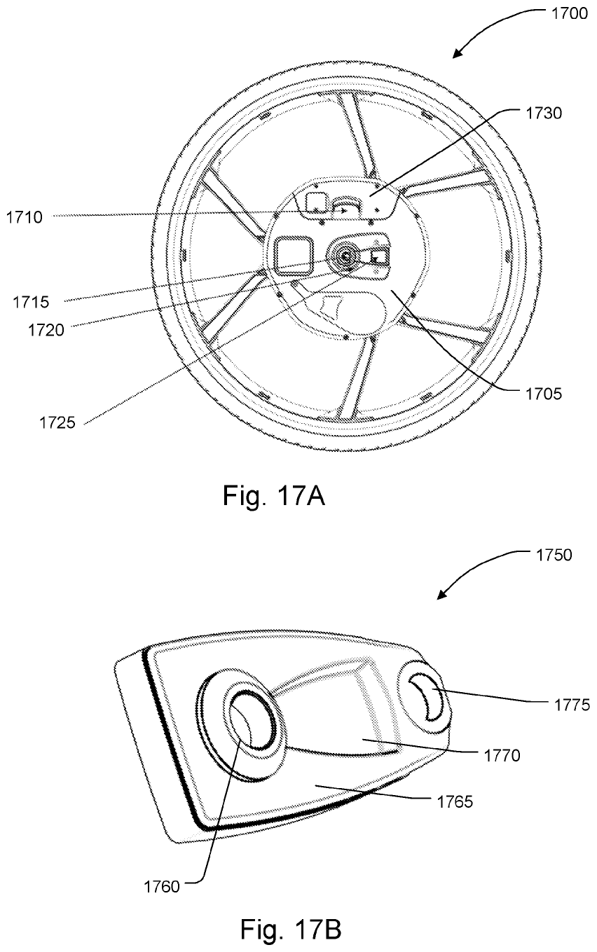

FIG. 17A shows a powered wheel 1700, similar to powered wheels such as the powered wheel 1210, the powered wheel 200 and the powered wheel 1100. The powered wheel 1700 has hub 1705 with an attached battery 1730 and a battery release 1710 to release the battery 1730 from the hub 1705. An axle 1715 is provided to mount the powered wheel 1700 to a wheelchair. The powered wheel 1700 also has a cassette 1720 which provides structural support for the hub 1705 for both the axle 1715 and a locking pin 1725.

FIG. 17B shows a right integration bracket 1750, similar to the right integration bracket 950 described above. The right integration bracket 1750 has a threaded axel insert 1760 through which the axle 1715 can pass. A scuff plate 1765 provides a surface over which the locking pin 1725 scrapes during an engagement process. The locking pin 1725 travels over the scuff plate 1765 before mating with a locking pin receiver 1770 where the locking pin 1725 is securely engaged until disengaged by a user of the wheelchair. The right integration bracket 1750 also has a magnet 1775 to allow the powered wheel 1700 to determine which side of the wheelchair the powered wheel 1700 is mounted. As described above, only the right hand side integration bracket has a magnet to indicate the powered wheel 1700 is mounted to the right hand side.

### Automated Locking Pin Process

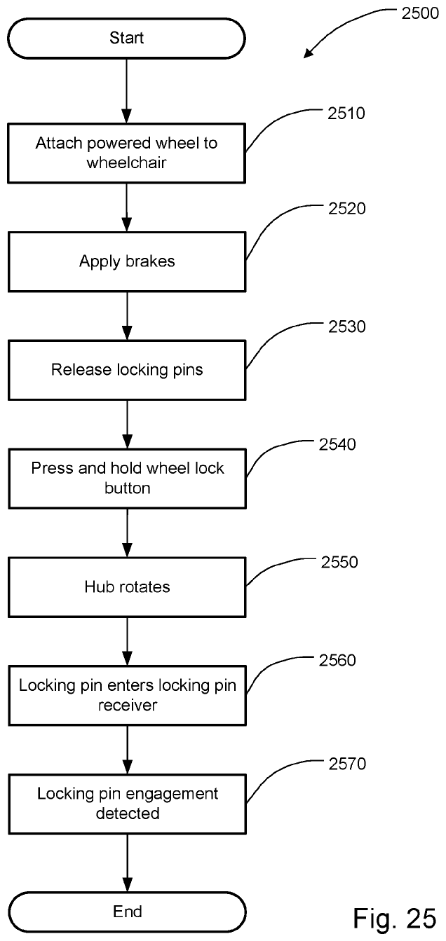

FIG. 25 shows an automated locking pin process 2500 that may be executed by a drive controller on a powered wheel, such as powered wheel 1700 or the powered wheel 1100. The drive controller executes the automated locking pin process 2500 to change the powered wheel from a freewheel mode to a powered mode. The automated locking pin process 2500 allows a user of the wheelchair to engage the locking pins of the powered wheels so the powered wheels can move the wheelchair.

The automated locking pin process 2500 starts with an attach wheel 2510 step, if the powered wheel is not already attached to the wheelchair. At apply brakes 2520, brakes for the wheelchair are applied to make sure that the wheelchair is restrained. Typically a manual park brake is applied to allow a user of the wheelchair to have at least one hand free for later steps of the automated locking pin process 2500, however the user of the wheelchair may be able to hold the wheelchair stationary using the wheels if the wheelchair is on a level surface.

At a release locking pin 2530 the locking pin on the powered wheel is released using a locking mechanism, such as the locking mechanism 230 of the powered wheel 200. The locking mechanism is used to retract or release the locking pin of the powered wheel. The locking pin can be released without any requirement to line up the locking pin with the locking pin receiver of the integration bracket. The automated locking pin process 2500 assumes that the locking pin is not aligned with the locking pin receiver. In a situation where the locking pin is aligned with the locking pin receiver, some of the following steps are not required as the drive controller will detect that the locking in has been engaged. In some embodiments, there is no need for the release locking pin 2530 as the locking pin may be in a released state when the powered wheel is attached at the attach wheel 2510 step.

At a press wheel lock button 2540 a button is pressed by a user of the wheelchair to engage the locking pin on the powered wheel. The button may be located on a controller of the wheelchair or may be located on the powered wheel. In one embodiment, the wheel lock button is located at a centre of the locking mechanism. The wheel lock button may be required to be held to ensure that the button press is not an accidental press. In another embodiment, the user presses a controlling joystick forward to start the process. Holding the joystick in a forward position continues the automated locking pin process 2500.

Once the press wheel lock button 2540 occurs, a hub rotation 2550 may start. The hub rotation 2550 may occur as long as the user continues to press the wheel lock button or until the locking pin engages with the locking pin recess. During hub rotation 2550, the hub rotates while the powered wheel is held stationary by the wheelchair brake. During normal operation, the hub is configured to spin the powered wheel when the locking pin are engaged with the locking pin receiver of the integration bracket. However, when the locking pin is not engaged, the hub rotates freely about the powered wheel when the powered wheel is held in place. The hub can rotate and the design of the locking pin and the integration bracket allows the locking pin to be pushed in and slide across the scuff plate before engaging in the locking pin receiver. The locking pin is spring loaded to allow the locking pin to be pushed in as the locking pin moves across the scuff plate of the integration bracket to engage with the locking pin receiver. Once engaged with the locking pin receiver, the locking pin is secured in place until released by the user using the locking mechanism.

At a pin lock 2560 the locking pin passes over the scuff plate of the integration bracket and is captured, or engaged, by the locking pin receiver. The integration bracket depresses the locking pin, pushing the locking pin towards the powered wheel. As the locking pin is spring loaded, the spring will push the locking pin to enter the locking pin receiver. At a pin engagement detection 2570 the drive controller determines that the locking pin is engaged with the locking pin receiver. In one embodiment, this is done by detecting an increase in power consumption, such as an increase in current, for the powered wheel motor while the powered wheel does not rotate. Similarly, torque applied to the motor may also be measured using motor current. In another embodiment, the engagement of the locking pin can be detect by limit switches for the locking pin in the hub. In another embodiment, a magnet located in the locking pin receiver may be detected by a reed switch in the locking pin. Once the pin engagement detection 2570 determines that the locking pin is in position, the automated locking pin process 2500 ends as the powered wheel is ready to operate in a powered mode.

### Plug and Socket

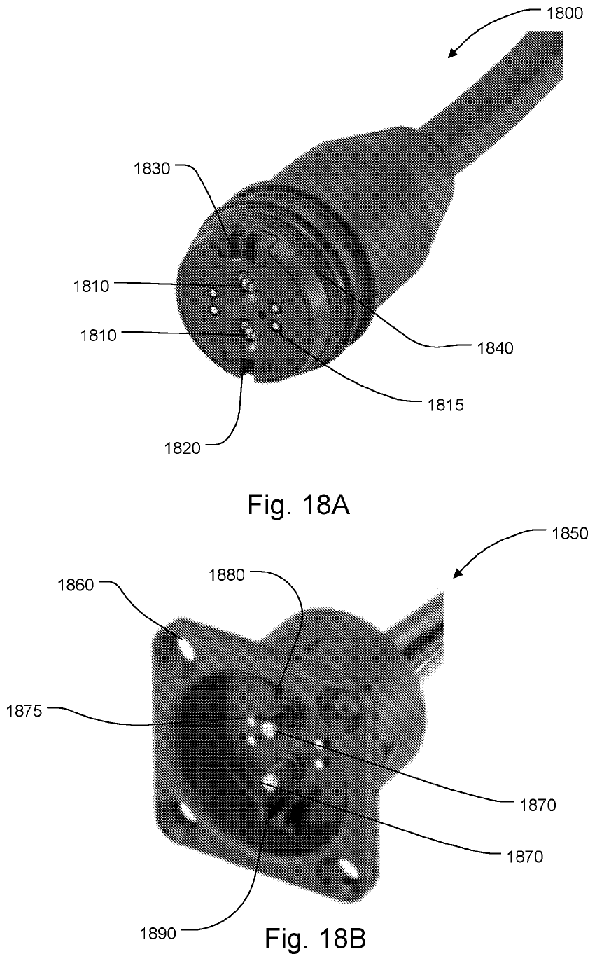

FIG. 18A shows a plug 1800 that is an example of a type of plug that can be used to recharge a battery while the battery is connected to a hub, such as hub 1705, or to recharge a battery, such as the battery 1730 when separate from the hub 1705. The plug 1800 has two slots 1810 for connecting to prongs in a socket. The slots 1810 have a fixed polarity and require the plug 1800 to connect to a socket in a predetermined orientation. To ensure correct orientation during connection, the plug 1800 has a single alignment slot 1820 on one side and a double alignment slot 1830 on an opposite side. The use of single and double alignment slots ensure correct orientation when the plug 1800 is connected to a socket. The plug 1800 also has a dust seal 1840, made from a number of small ribs, to prevent dust moving in to the socket when the plug 1800 is inserted. Data slots 1815 may be used to carry data signals in addition to the power conducted on the slots 1810.

FIG. 18B shows a socket 1850 that can be used with the plug 1800. The socket 1850 is configured for panel mounting with a panel mount flange 1860, however other arrangements may also be used. The socket 1850 has two prongs 1870 that connect to the slots 1810. A single alignment protrusion 1880 is position to align with the single alignment slot 1820 while a double alignment protrusion 1890 is positioned to align with the double alignment slot 1830. The plug 1800 and socket 1850 are design to press fit together and are held in position using friction between the plug 1800 and the socket 1850. The dust seal 1840 may also assist in providing a suitable level of friction between the plug 1800 and the socket 1850. Data prongs 1875 are also provided to connect with the data slots 1815.

### Bung

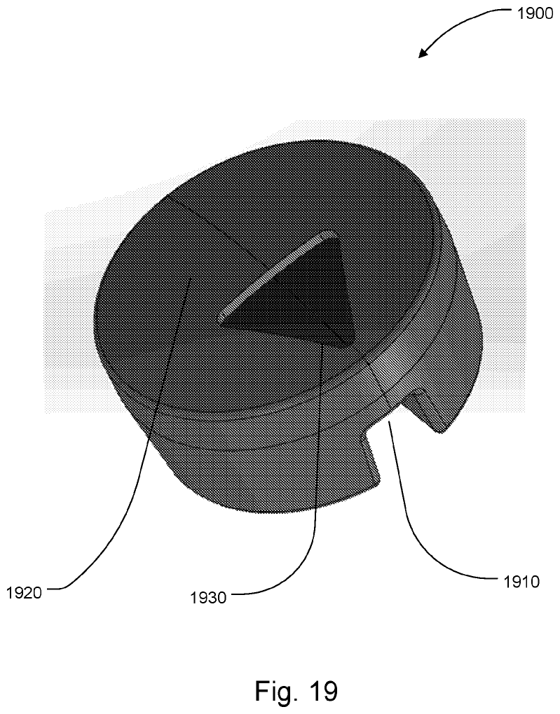

A bung 1900 may be placed in an unused socket, such as the socket 1850, to prevent dirt and/or liquids from entering the socket. The bung 1900 will now be described in relation to FIGS. 19, 20A, 20B, 21A and 21B. The bung 1900 is placed in the socket by a user and held in place using one or more magnets. The bung 1900 is cylindrical in shape to match the shape of the socket. A convex surface 1920 is located on the external surface of the bung 1900, that being the surface that is exposed when the bung 1900 is placed in the socket. Located on the convex surface 1920 is an alignment indicator 1930, shown as a triangle pointing to a location on an edge of the convex surface 1920.

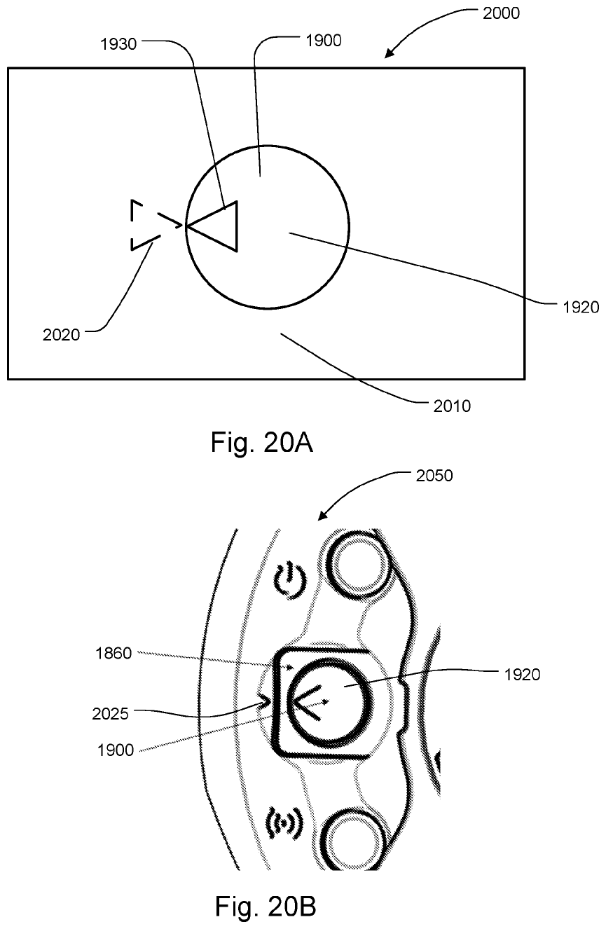

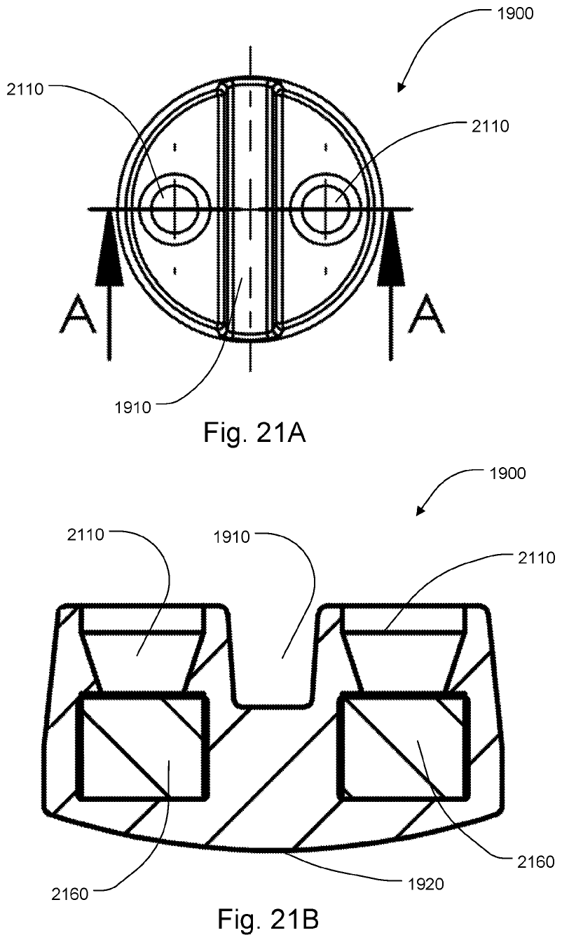

The alignment indicator 1930 can be used as shown in FIGS. 20A and 20B to align a void 1910 in the bung 1900 with pins and/or alignment protrusions of the socket. FIG. 20A shows an installed bung 2000, with the bung 1900 placed in a socket that is mounted to a panel 2010. An alignment indicator 1930 is lined up with a panel alignment indicator 2020 so that the installed bung 2000 is correctly aligned. Another example installed bung 2050 is shown in FIG. 20B that uses an alternative panel alignment indicator 2025. The bung 1900 is placed in the socket and a panel mount flange of the socket, such as the panel mount flange 1860 is visible.

FIG. 21A shows an underside of the bung 1900.The underside shows two prong recesses 2110 where prongs from the socket are inserted when the bung 1900 is placed in the socket. As shown in FIG. 21A, the void 1910 spans from one side of the bung 1900 to the other. The void 1910 provides space for the alignment protrusions to fit within the bung 1900. FIG. 21B shows a cross section of the bung 1900 taken as AA from FIG. 21A. Located inside the bung 1900 are two embedded magnets 2160. The embedded magnets 2160 serve two purposes. The first is that the embedded magnets 2160 hold the bung 1900 in place when inserted in the socket. The embedded magnets 2160 provide attraction to the prongs of the socket, sufficient to hold the bung 1900 in place. The embedded magnets 2160 also provide sufficient attraction to magnets in a matching cap to allow the cap to remove the bung 1900. This will be described in more detail below.

### Cap

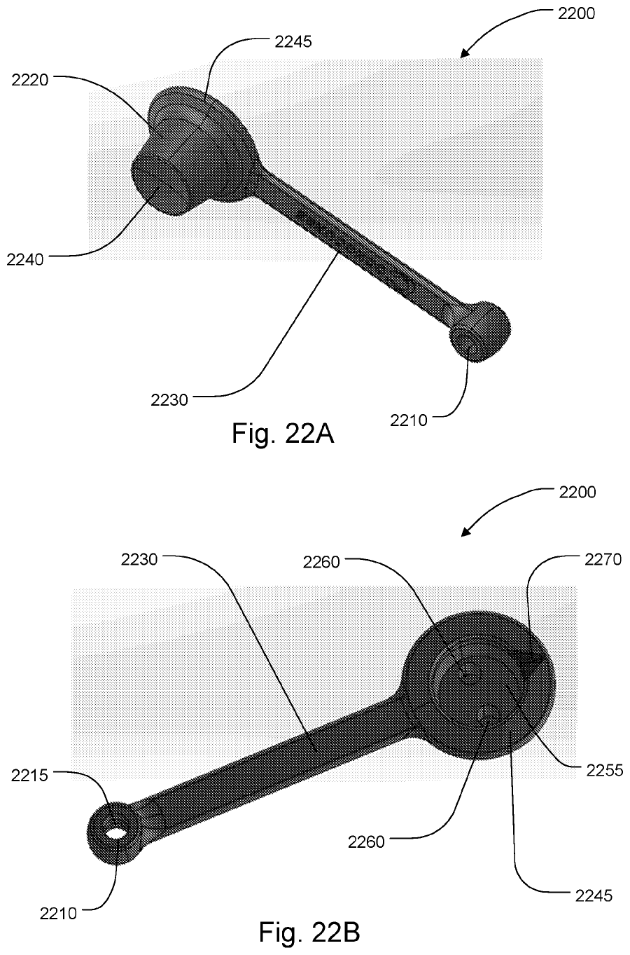

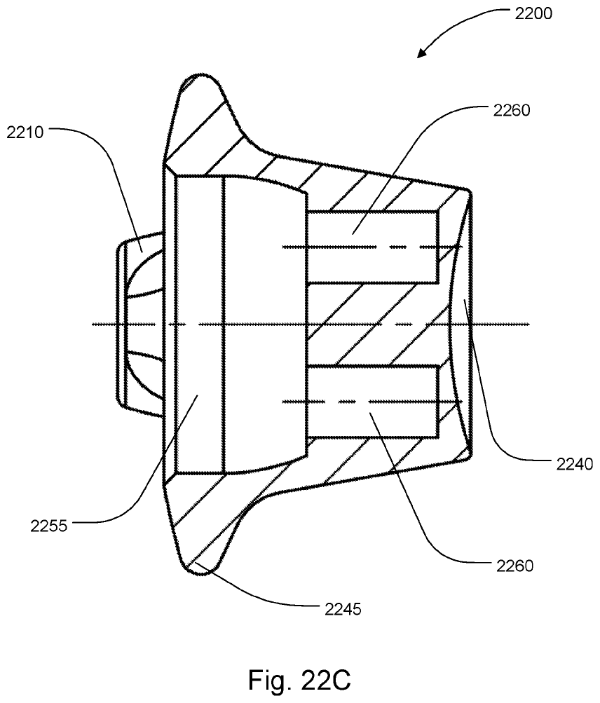

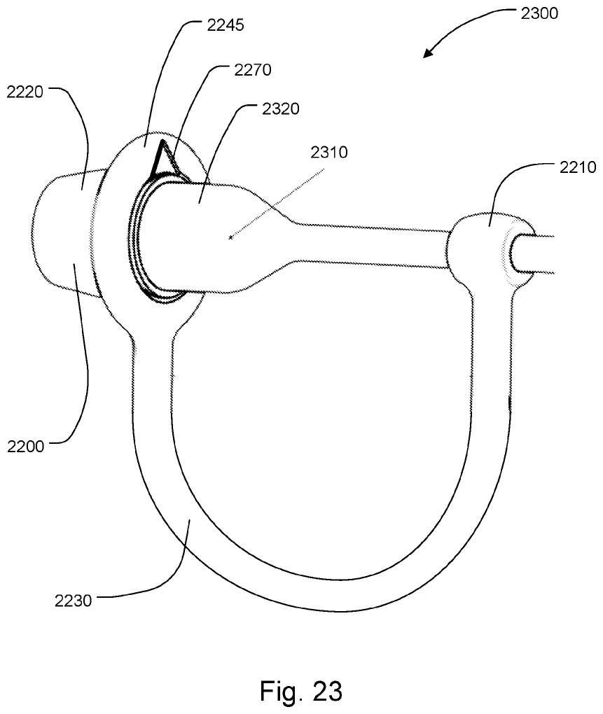

A cap 2200 for a plug, such as the plug 1800, will now be described in relation to FIGS. 22A, 22B, 22C and 23. A back view of the cap back 2200 is shown in FIG. 22A, a front view of the cap back 2200 in FIG. 22B and a cross section is shown in FIG. 22C. The cap 2200 has a cable attachment end 2210 with a cable aperture 2215 for a cable to pass through. In one embodiment, the cable attachment end 2210 is flexible enough to stretch over the socket and be placed on the cable. In another embodiment, the cable attachment end 2210 can be disconnected to allow the cable to be inserted, before being re-joined. A tether 2230 connects the cable attachment end 2210 to a cap end 2220. On the outside of the cap end 2220 is a concave surface 2240 which is designed to have a matching profile to the convex surface 1920 of the bung 1900, allowing the cap 2200 to remove the bung 1900 from a socket, as will be described in more detail below.

The cap 2200 also has a flange 2245 extending around the circumference of the cap 2200. The flange 2245 provides a suitable surface for a user to grip the cap 2200 when inserting or removing the plug. The flange 2245 has an alignment indicator 2270 that can be used to align the cap 2200 with the plug. The alignment indicator 2270 aligns the slots on the plug, such as the slots 1810, with magnets 2260 located in a socket recess 2255. The socket recess 2255 is where the socket is inserted when the cap 2200 is placed over the end of the socket.

A cross section of the cap 2200 is shown in FIG. 22C with the two magnets 2260. The magnets 2260 are cylindrical in shape and positioned close to both a surface of the socket recess 2255 as well as the concave surface 2240. The magnets 2260 provide a magnetic force with the metal of the slots of the socket to hold, or assist in holding, the cap 2200 on the socket. The magnets 2260 are also close to the concave surface 2240. As mentioned above, the cap 2200 may be used to remove the bung 1900 from the socket. To remove the bung 1900, the concave surface 2240 is placed on the convex surface 1920 of the bung 1900. The alignment indicator 2270 is aligned with alignment indicator 1930 to make sure that the polarity of the magnets 2260 and the embedded magnets 2160 are also aligned. When the bung 1900 is located in the socket, a panel alignment indicator, like the panel alignment indicator 2020, may be used to align the alignment indicator 2270. The embedded magnets 2160 of the bung 1900 and the magnets 2260 are positioned in a manner that the magnetic force between the bung 1900 and the cap 2200 is stronger than the magnetic force, or attraction, between the bung 1900 and the prongs of the socket. One example of how this may be done is to position the embedded magnets 2160 of the bung 1900 closer to the convex surface 1920 than the surface of the prong recesses 2110. When configured correctly, the cap 2200 is placed in contact with the bung 1900, with correct alignment, and pulling the cap 2200 away from the socket will remove the bung 1900.

An installed cap 2300 is shown in FIG. 23 where the cap 2200 is attached to the cable 2310. The cable attachment end 2210 is wrapped around the cable 2310. The cap end 2220 is placed on the socket 2320. The alignment indicator 2270 on the flange 2245 is aligned with an indicator, not shown, on the socket 2320 so that the magnets 2260 align with the slots of the socket 2320.

### Bung Removal Process

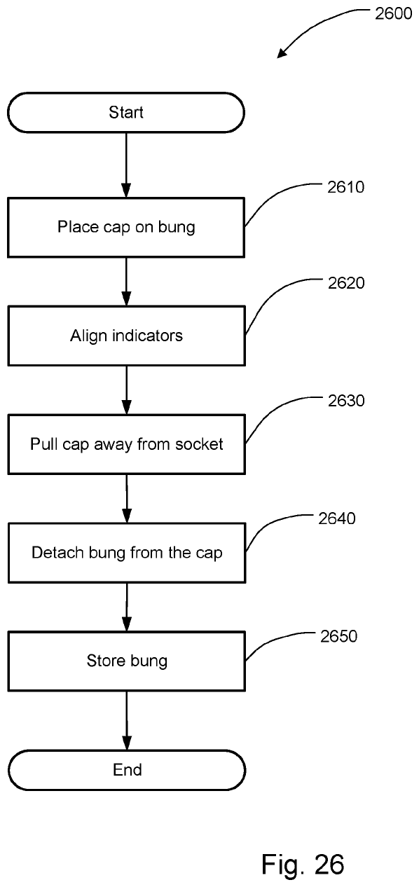

A bung removal process 2600 will now be described in relation to FIG. 26. The bung removal process 2600 is performed by a person, such as a user of the wheelchair fitted with powered wheels, to remove a bung, such as the bung 1900, using a cap, such as the cap 2200. At the start of the bung removal process 2600 the bung is already inserted in a socket to prevent dirt and liquid from entering the socket.

At position cap 2610 the concave surface 2240 of the cap 2200 in mated to the convex surface 1920 of the bung 1900. The convex surface 1920 and the concave surface 2240 are designed to be complementary shapes and could be swapped such that the convex surface is on the cap 2200 and the concave surface is on the bung 1900. In one embodiment the two surfaces are flat.

At align indicators 2620, an alignment indicator on the panel may be used to align the alignment indicator 2270 of the cap 2200 so that the bung 1900 and the cap 2200 are correctly aligned. The alignment is important to ensure that the magnets are adjacently located and have suitable polarity to attract the adjacent magnets. Alternatively, before placing the cap 2200 on the bung 1900 the user may note the orientation of the alignment indicator 1930 and align the cap 2200 with the bung 1900. When the bung 1900 and the cap 2200 are correctly aligned, the embedded magnets 2160 of the bung 1900 will be attracted to the magnets 2260 of the cap 2200. The attraction between the magnets is stronger than the attraction of the embedded magnets 2160 to the prongs of the socket.

At remove bung 2630 the cap 2200 is pulled away to remove the bung 1900 from the socket. The cap 2200 is pulled in a direction that is away from the socket, in a direction approximately normal to a surface of the face of the socket. Should the user change their mind before removing the bung 1900, the user may move the cap 2200 to one side of the socket, moving parallel to a face/surface of the socket, to disengage the embedded magnets 2160 from the magnets 2260.

At detach the bung from the cap 2640 the bung 1900 may be removed from the cap 2200. The magnetic force securing he bung 1900 to the cap 2200 can be overcome by the user. Finally, at store the bung 2650, the bung 1900 is placed in a storage location. In one example, the storage is a dummy socket that allows the bung 1900 to remain in position. In another embodiment, the bung 1900 is placed in a pocket of the wheelchair. In one embodiment, the bung 1900 may be stored in the cap 2200 with the magnets holding the bung 1900 in position.

### Powered Wheel Control System

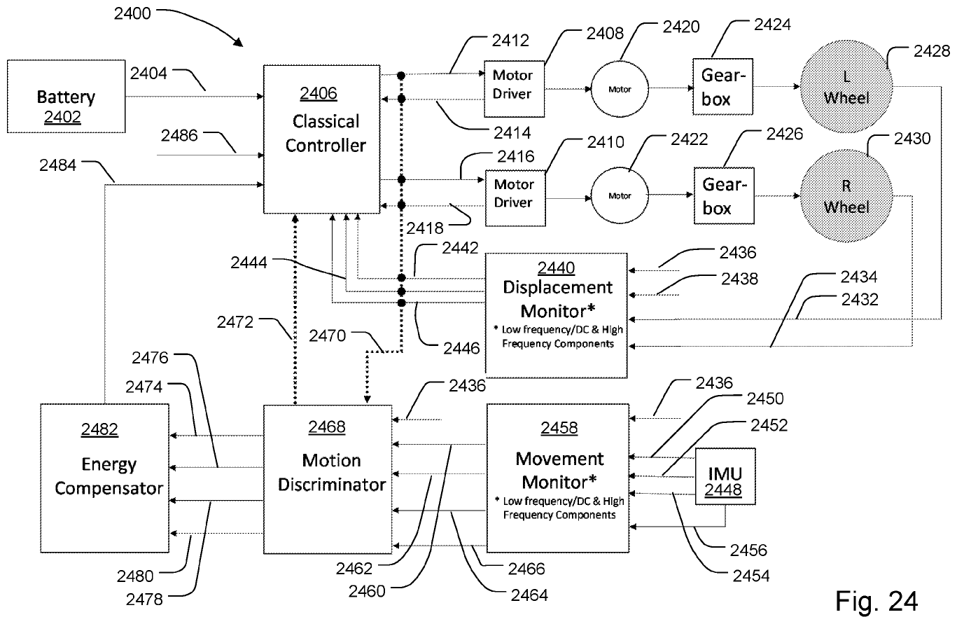

A control system 2400 will now be described in relation to FIG. 24. The control system 2400 is located in a hub of a powered wheel, such as the powered wheel 1700, and shows the combined operation of two powered wheels attached to a wheelchair. The control system 2400 is in both a left powered wheel and a right powered wheel attached to a wheelchair, with data communicated between the left and right powered wheels to form a complete system to control the wheelchair. Unless mentioned otherwise, any physical component described as left is located in the left powered wheel and any physical component described as right is located in the right powered wheel. Signals described as left may originate in the left powered wheel, but can be transmitted to the right powered wheel as required. Similarly, signals described as right originate in the right powered wheel, but can be transmitted to the left powered wheel, if required. The signals from the right powered wheel may be transmitted to the left powered wheel is the left powered wheel is selected as the primary controller to the right powered wheel. Typically, the right powered wheel is the primary controller. While the powered wheels may be described as left and right, the powered wheels are physically identical and interchangeable, such that each powered wheel can be swapped between sides of the wheelchair. Once the powered wheels are attached to the wheelchair they are then configured to operate according to which side of the wheelchair they are attached.

Each powered wheel has a battery 2402 that provides a current signal 2404 to a controller 2406. The controller 2406 of the powered wheel sends and receives a number of inputs and outputs. The controller 2406 can control a motor located in a hub of the powered wheel, however one of the controllers 2406 in the left or right powered wheels operates as a primary controller to send command to the other powered wheel. In one embodiment, the controller 2406 located in the hub of the right powered wheel is the primary and sends commands to the controller 2406 in the left powered wheel. In the left powered wheel the controller 2406 communicates with a left motor driver 2408 which receives a left motor duty 2412 command to instruct the left motor driver 2408 to drive a left motor 2420. The left motor driver 2408 transmits a left motor current 2414 to the controller 2406 so that the controller 2406 can determine how much power the left motor 2420 consumes. Output of the left motor 2420 is transmitted through a left gearbox 2424 to drive a left wheel 2428. A left wheel speed 2432 is reported to a displacement monitor 2440

Similarly, the right powered wheel has a right motor driver 2410 that receives a right motor duty 2416 from the right controller 2406 and returns a right motor current 2418 to the right controller 2406. The right motor driver 2410 drives a right motor 2422 which, in turn, drives a right gearbox 2426 to rotate a right wheel 2430. The right wheel 2430 has a right wheel speed 2434 that is reported to a right displacement monitor 2440.

The displacement monitor 2440 in each wheel determines also receives a time 2436 and a wheel diameter 2438. From the inputs to the displacement monitor 2440 the following data is determined and output: a displacement 2442, a velocity 2444 and an acceleration 2446 for the powered wheel. The information from the displacement monitor 2440 is sent to the controller 2406.

An inertial measurement unit 2448 is located in each powered wheel to determine movement information, for the powered wheel, that can be applied to the wheelchair. The inertial measurement unit 2448 provides roll 2450, pitch 2452, yaw 2454, and position 2456 information to a movement monitor 2458. The movement monitor 2458 also receives the time 2436 information. The movement monitor 2458 outputs pose information for the wheelchair that includes heading 2460, facing slope 2462, side slope 2464, and change in vertical acceleration 2466 information to a motion discriminator 2468. The facing slope 2462 is a measure of the slope of the wheelchair in a forwards direction and the side slope 2464 is a measure of the slope of the wheelchair in a left right direction. Using the facing slope 2462 and the side slope 2464 allows the motion discriminator 2468 to determine a plane on which the powered wheel sits. The plane for the powered wheel is also the plane on which the wheelchair sits.

The motion discriminator 2468 also receives the left motor duty 2412, left motor current 2414, right motor duty 2416, right motor current 2418, displacement 2442, velocity 2444 and the acceleration 2446 information from a signal bus 2470. Although shown as connecting to the data lines to the controller 2406, the signal bus 2470 may be sent from the controller 2406 that collects information from the left powered wheel when control system 2400 is the right powered wheel. The motion discriminator 2468 also sends information to the controller 2406 via motion data 2472. The time 2436 is also input to the motion discriminator 2468.

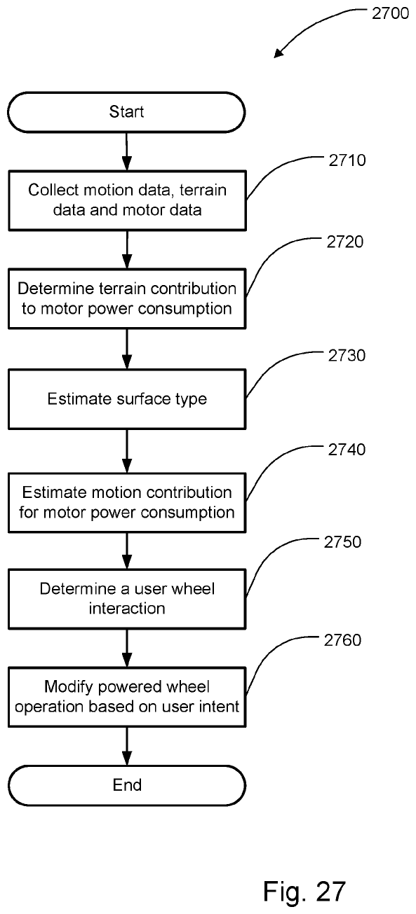

The motion discriminator 2468 uses all the received information to determine information about the operational state of the wheelchair. The motion discriminator 2468 knows pose information (such as information of heading, roll, pitch and yaw or derived information) for the wheelchair as well as motion information (displacement, velocity and acceleration). The motion information also has information about a contribution of the left wheel 2428 and the right wheel 2430 to the wheelchair movement and can use that, along with the information provided from the movement monitor 2458 to determine a current state of the wheelchair. Additionally, the motion discriminator 2468 also knows an operational state of the left motor 2420 and the right motor 2422. This allows the motion discriminator 2468 to determine how much power each motor is using to generate the movement of the wheelchair. Operation of the motion discriminator 2468 will be described in more detail in relation to FIG. 27 below.

The motion discriminator 2468 outputs kinetic energy data 2474, potential energy data 2476, L/R change data 2478 and L/R terrain data 2480 to an energy compensator 2482. The L/R change data 2478 is a measure of how much the left and the right powered wheels have advanced or retreated. The L/R terrain data 2480 is terrain information for the left and the right powered wheels. The energy compensator 2482 takes into account the information and determines how to modify output of the left motor 2420 and the right motor 2422. The modification information is sent to the controller 2406 via a compensator command 2484. The compensator command 2484 is combined with user commands 2486 to vary the left motor duty 2412 and the right motor duty 2416 to compensate operation of the left motor 2420 and the right motor 2422 based on terrain information and user interaction with the powered wheels.

As described above, most of the operations of the control system 2400 are performed in a powered wheel with one powered wheel operating as primary for the controller 2406. Each of the left and the right displacement monitors 2440 collects data for their corresponding wheel, either the left wheel 2428 or the right wheel 2430. In one embodiment the movement monitor 2458, motion discriminator 2468, energy compensator 2482 and displacement monitor 2440 determine all information, or data, for each wheel. The controller 2406 communicates between a primary and secondary powered wheel to share data between the left and the right powered wheels.

A summary of the characteristics of influences and measures of the control system 2400 is provided. The control system 2400 provides direct command of motor common mode speed between the left and right powered wheel, both positive and negative, and motor differential mode speed between the left and right powered wheels, both positive and negative. The control system 2400 also determines user interaction with the left and right powered wheel common mode speed, both advance and retard, as well as left and right powered wheel differential mode speed, advance and retard.

For the terrain, the following factors operate in common and differential modes for both the left and the right powered wheels. A softness or hardness of the ground; smoothness or roughness of ground, which includes ground corrugation and wheel diameter; inclination/declination of facing-slope; inclination/declination of side-slope; as well step changes in factors above, with various degrees of change severity.

The inertial measurement unit 2448 provides measurements that can be used to determine a heading (yaw), roll and pitch. All three can be static, impulse and cyclic, and delta or “change-in” values.

The left motor driver 2408 or the right motor driver 2410 can use the following base measures, controlled and/or measured: motor current (wheel torque), or motor speed (wheel speed). Both measures may be measured as static, impulse and cyclic, and/or delta/“change-in”.

The following synthetic measures are deduced and estimated by sensor fusion and may be static, impulse and cyclic, and/or “change-in”: wheelchair horizontal displacement, velocity and acceleration; wheelchair vertical displacement, velocity and acceleration; wheelchair gross and net mass; wheelchair kinetic energy; and wheelchair change in potential energy.

On this basis, using state memory, and correlation of the raw, base and derived sensor measurements, the input energy flow can be directly measured, and then correlated with the terrain characteristics, and thus interchange in potential and kinetic energy, from which the residual energy deficit is deduced as being caused by manual manipulation of the wheelchair push-rims by a user, either by complimenting the counterpart net energy (i.e. relieving other energy sources, such as the motors of the powered wheels, of burden), or working against the counterpart net energy (i.e. preventing other energy sources, such as the motors of the powered wheels, from creating (additional) action.

These measures are then used to optimally respond to the intent of the wheelchair user by modulation or adjusting the motor drive current. The measures have other ancillary application including electrical energy management and prediction, and thermal reserve management and thermal limit prediction based on current and historical context.

### Powered Wheel Control Process

A powered wheel control process 2700 will now be described with reference to FIG. 27. The powered wheel control process 2700 is implemented by the control system 2400 and may be duplicated in each of the left and the right powered wheels. The powered wheel control process 2700 may execute as a loop when the powered wheels are engaged with the integration bracket. The powered wheel control process 2700 collects information from sensors, such as the inertial measurement unit 2448, the left motor driver 2408 or the right motor driver 2410, as well as the motion discriminator 2468 and the energy compensator 2482. The information is used to determine a comparison between an intended operation of each of the powered wheels and actual operation. One or more reasons for a difference between the intended powered wheel operation and the actual powered wheel operation is determined. Based on the one or more reasons for the difference, a modification in the operation of the powered wheel is determined for the left powered wheel, the right powered wheel, or both powered wheels.

The powered wheel control process 2700 starts with data collection 2710, where motion data, terrain data and motor data is collected. The motion data is derived information from the inertial measurement unit 2448 and the displacement monitor 2440 and may include the change in vertical acceleration 2466 along with the displacement 2442, the velocity 2444 and the acceleration 2446. The motor data is the left motor current 2414 and/or the right motor current 2418. The motor data may also include the left motor duty 2412 and/or the right motor duty 2416. The terrain data includes derived information such as the heading 2460, the facing slope 2462, and the side slope 2464 and is sometimes referred to as the pose data.

A terrain contribution determination 2720 determines the effect of the pose, or a pose contribution, and the effect of a surface, or surface contribution, to power requirements for the motor. First the pose is used to determine the pose contribution, being how much power is applied to the motor based on the pose of the wheelchair. The pose data is used to determine how much power the motor of each powered wheel should be using based on a pose of the wheelchair. The pose component of the terrain contribution determination 2720 uses the slope information, the velocity, acceleration as well as a basic model of the wheelchair to determine the power required by each wheel motor based on the wheelchair pose. For example, if the wheelchair is determined to be facing uphill, then gravity is resisting motion of the wheelchair and high motor power will be required for the wheelchair to travel uphill. If the wheelchair is travelling across a slope, then the left and the right motors may require different amounts of power as the wheelchair may be trying to yaw due to gravity of the slope.

In addition to a pose contribution, power consumed based on a surface contribution may also be determined by comparing expected motion data and to collected motion data, when taking into account the motor data. In one example, the speed of the wheelchair may be lower than expected, for a certain motor power, due to an amount of drag from the surface. The terrain contribution determination 2720 will determine power consumption for each powered wheel motor that is used to overcome resistance of the surface. For example, a soft surface will require more power to move the wheelchair than a hard surface, when all other factors are the same.

A surface type estimation 2730 takes the surface contribution, being the power consumption attributed to the surface type, to select a surface type that the wheelchair is travelling over. The surface type is determined for a surface that each powered wheel is on. Some example surface types include smooth or rough as well as hard or soft surfaces. The smoothness and hardness of the surface may also be combined so there is a smooth hard surface, such as concrete or bitumen, or a rough and hard surface, such as rough concrete or firmly packed gravel. A soft and rough surface may be wet turf. A lookup table may be used to account for the surface type and how the surface type changes power consumption for the motors to provide an estimate change in the power consumption for the motor. The surface type may be used for a next iteration of the terrain contribution determination 2720 when the powered wheel control process 2700 is executed next.

In one embodiment, the surface type may be a surface impedance factor, with a low surface impedance factor indicating a smooth hard surface, such as polished concrete, and a high surface impedance factor indicating a difficult surface for a wheelchair wheel to move through, such as soft grass or even sand. In one example the surface impedance factor is a value between 0 and 10, with 0 being a very smooth and hard surface and 10 being a very soft and/or rough surface. The surface impedance factor can then be used to determine a change in power consumption for the motors of the powered wheels.

In one example, the surface type, or surface impedance factor, may be determined for each powered wheel. This may be useful in situations where the left and the right powered wheels are on different surface types.

At motion factors estimation 2740 may take into account a motion contribution from the acceleration 2446 by the wheelchair as well as increases or decreases in the kinetic energy data 2474 or the potential energy data 2476. Estimates of the motor power required for the acceleration or change in kinetic or potential energy can be determined.

At a user wheel interaction determination 2750 any unaccounted power draw by the motor may be attributed to user interaction with a wheel. That is, any discrepancy between the actual power used by the motor and the power expected to be used by current wheelchair motion, when taking into account environmental factors such as pose contribution from the terrain contribution determination 2720 and surface information from the surface type estimation 2730, is attributed to user interaction. For example, if a user grabs the left wheel to change direction of the wheelchair to the left, the motor for the left wheel will have additional power draw that is not accounted for by the pose contribution, the terrain contribution or the motion contribution. The unaccounted power draw will typically be for only one of the two powered wheels. In another example, the user of the wheelchair may push the right wheel forward. The result will be that the wheelchair is turning left and the right powered wheel is using less power than expected for the pose contribution, the surface contribution and the motion contribution.

At a modify wheelchair operation 2760 the pose contribution, surface contribution, motion contribution and the user wheel interaction may be combined to determine modifications to the operation of the powered wheels. For example, the pose contribution may be used to make sure that the wheelchair moves in a straight line as the wheelchair moves across a slope. The user wheel interaction may be used to allow a change in a direction of the wheelchair.

While the terrain contribution determination 2720, the surface type estimation 2730, the motion factors estimation 2740 and the user wheel interaction determination 2750 are shown in a specific ordering in powered wheel control process 2700, other processing orders may be used.

### Electronic Lossless Ratchet

In one embodiment, the control system 2400 of the powered wheels can provides an electronic ratchet, that models a mechanical ratchet, to allow movement of the powered wheels in only one direction. The electronic ratchet does not use a mechanical ratchet or mechanical friction. Instead, the electronic ratchet allows movement of a powered wheel in one direction, when the wheelchair with the powered wheels is under manual control. The electronic ratchet may have multiple modes. In one mode, the electronic ratchet operates based on a direction of travel of the wheelchair with the direction of travel being the allowed direction for the wheelchair to move. If the wheelchair moves in a different direction, then the powered wheels will prevent movement. In another mode, the electronic ratchet operates based on an incline the wheelchair is on, relative to the direction of travel. In this mode, the wheelchair will be able to move uphill, but not downhill. In a third mode, the electronic ratchet operates based on a direction of last travel. In this mode, the wheelchair is stationary but is only able to move in the direction that the wheelchair was moving before it came to a stop. The electronic ratchet can be released using manual input to the wheel drive that is detected by the control system as unlatching (or retracting) the ratchet.

In one example, the electronic ratchet operates when the wheelchair with powered wheels is facing up hill and detected to be travelling uphill under manual control. The wheelchair can be manually “suggested” up the hill via user manual input by the user pushing on the push rims of one, or both, of the powered wheels. Pushing on the push rims of the powered wheels moves the wheelchair up the hill with low manual effort from the user.

When the wheelchair slows to a stop, either from deceleration due to gravity or from input from the wheelchair user, the control system detects the stopped condition and engages the electronic ratchet such that the wheelchair will not roll backwards/down the hill.

The electronic ratchet can be disengaged as follows. The wheelchair user moves the wheelchair forwards for a predetermined movement amount, where the predetermined movement is a predetermined speed, linear displacement across terrain, wheel rotational displacement, time, or a combination of two or more of speed/linear displacement/rotation displacement/time. The rotational displacement may be a predetermined rotation of either, or both, powered wheels of the wheelchair, such as 15 degrees rotation. The change in direction may occur while the wheelchair remains stationary. Once the predetermined forwards movement is complete a predetermined backwards movement must occur for a predetermined backwards movement amount. There should be little to no time gap between the wheelchair moving forwards and moving backwards for the electronic ratchet to disengage. Once the electronic ratchet is disengaged, the wheelchair is allowed to roll backwards. The rate of backwards movement may be limited by other functions of the powered wheels, such as being speed limited due to the slope the wheelchair is on. Moving the chair forward after this time causes the ratchet to re-engage, thus, this is also representative of the overall function for reactivating the ratchet. In an alternative embodiment, the electronic ratchet may be activated and deactivated using an additional button on a remote control, such as the remote control 700. The electronic ratchet may also disengage once the wheelchair is determined to be on a flat, or substantially flat, surface.

The electronic ratchet operates in a similar manner to a mechanical ratchet system, but uses the braking feature of the powered wheels to prevent wheelchair movement in the blocked movement direction. For typical operation of the electronic ratchet in the forwards direction, the blocked direction is backwards. In one example, to move the wheelchair forwards, the user of the wheelchair can move the wheelchair over a predetermined electronic ratchet detent threshold, such as a predetermined speed, linear displacement across terrain, rotational displacement, time, or a combination of two or more of speed/linear displacement/rotation displacements/time. If the wheelchair does not move past the predetermined electronic ratchet detent threshold, then the wheelchair may mover by a very small amount, but return to a pre-movement location, i.e. the wheelchair will not move forward on the electronic ratchet and remain in place. This allows for small movements of the wheelchair, such as movement caused by movement of the user, without moving the wheelchair. When the wheelchair moves past the predetermined electronic ratchet detent threshold then a stopping location of the wheelchair, where the electronic ratchet is applied, will be updated depending on the movement of the wheelchair. When the movement of the chair is in a direction allowed by the electronic ratchet, the brake of the powered wheels is released. The wheelchair can then move as directed by a user, in the allowed direction. Once the wheelchair comes to a stop the brake is reapplied to prevent the wheelchair from moving in the blocked direction.

While the above describes use of the electronic ratchet to prevent the wheelchair from rolling back down a slope, the electronic ratchet may also be used when going down a slope. Operation of the electronic ratchet in a downhill mode is symmetrical inverse to the uphill mode, described above, with the wheelchair being prevented from moving down the slope by the electronic ratchet. When the wheelchair is facing downhill and at rest, the electronic ratchet prevents the wheelchair from moving down the slope, but allows the wheelchair to move up the hill, in reverse, by the user manual pushing the rims of the powered. However, the wheelchair will be prevented from moving down the hill.

To release the ratchet in the downhill mode, to allow the user to move down the hill, the chair is reversed by manually pushing on the push rims to momentarily release the electronic ratchet. Before the electronic ratchet engages, the wheelchair is manually moved forward, downhill, using the wheel rims. In one embodiment, the wheelchair user applies force that exceeds a predetermined threshold. The applied force that the powered wheels detects is a force greater than gravitational pull, where the detected force exceeds gravitational pull by the predetermined force threshold. Once the downhill mode ratchet is disabled the wheelchair can roll downhill, but may have a limited speed.

### Virtual Cruise Control

In one embodiment, a wheelchair fitted with the powered wheels can be operated at a number of predetermined speeds, in a manner similar to a cruise control with multiple predetermined speeds that the wheelchair may operate at. Examples may be 0.2, 0.4, 0.6, 0.8, 1.0, 1.2, and 1.4 meters per second or the speeds of 0.4, 0.8, 1.2, and 1.6 meters per second. The predetermined speeds may not be evenly spaced, such as 0.4, 0.8, 1.0, 1.2, 1.4 and 1.6 meters per second. To operate the wheelchair at one of the predetermined speeds, the user of the wheelchair applies manual force to the push rims of the powered wheels. The manual force is detected as an additional force that is not caused by external forces such as gravity. The manual force is determined as a selection of one of the predetermined speeds of the cruise control mode. If a manual force is applied when the cruise control is already active, then the control system may increase the speed of the wheelchair by selecting a faster cruise control speed. If the manual force is applied to slow the wheelchair, then a slower cruise control speed is applied. Once the wheelchair is operating at the selected cruise control speed, the speed will be held subject to user intervention or input. To stop the wheelchair the user may simply apply the manual force to slow the chair until the wheelchair stops.

The powered wheels may implement a speed affinity where changing between the predetermined speeds requires the user to exceed a speed change threshold. In one example, the speed change threshold is 50%. When the cruise control speed steps are 0.2 meters per second, such as changing the cruise control speed from 0.8 to 1.0 meters per second, a speed increase of at least 0.1 meters per second is required to move to the next predetermined speed. For cruise control speed steps of 0.4 meters per second, a speed increase of at least 0.2 meters per second is required. If the user does not increase the speed of the wheelchair by the speed change threshold then the wheelchair will continue to operate at the current cruise control speed. In other examples the speed change threshold may be 25%, 20%, 30%, 40% or 60%.

To start the wheelchair in the cruise control mode, the user may apply manual force to the wheel rims. The manual force is detected and the cruise control is activated if a speed of the wheelchair is close to a predefined cruise control speed. The cruise control speed is held until manual force is detected to increase or decrease the speed of the wheelchair. External, environmental, inputs, such as a downhill force, are rejected to prevent unintended changes to the cruise control speed.

In one embodiment, an incline of the surface upon which the wheelchair is driving is included in operational characteristics of the powered wheel equipped wheelchair. In this embodiment, the power provided by the powered wheels may be boosted for an incline, or reduced/braked for a decline. On a decline, speed increase caused by the down slope are ignored and a constant speed applied. Any additional forces, that exceed forces expected from the decline, will change the operation of the cruise control mode in the manner outlined above.

When the wheelchair is operating in the cruise control mode a jog wheel on the remote control, such as the remote control 700, can be used to select a faster or slower cruise control mode. Further, a push button on the remote control may be used to stop the wheelchair. The remote control may also have input to enable and disable operation of the cruise control mode.

### Variations

While a belt drive system has been described, alternative speed reduction arrangements may also be used. For example, gears or a combination of belts and gears may be used to reduce the shaft speed of the electric motor to a speed suitable for the output drive sprocket. Alternatively, a direct motor drive may be used. The electric motor used may be a DC motor or an AC motor. In one embodiment the electric motor is a brushless DC motor.

While the microprocessor, motor controller and wireless communications controller are described as being on a single printed circuit board of the drive controller, the drive controller may also be arranged as two or more separate printed circuit boards that are connected using cables or a bus.

While the removable battery has been described with certain voltage and power values, other battery configuration may also be used. Similarly the external battery charger 1340 may operate on different voltages. In one example, the removable battery has a USB type C port that allows charging of the battery using a USB cable and charger without the need for an external battery charger.

The design of the locking pins may be modified form the arrangements described above. In one example, two or more locking pins are located on each powered wheel. The locking pins may also have alternative shapes, such as square, circular or elliptical. In one example, the locking pin may move in a direction other than perpendicular to the plane of the powered wheel, such as 30 degrees from perpendicular. Such an arrangement may provide improved holding force for the powered wheel on to the wheelchair.

The remote control for the powered wheels generally operates as a single remote control operating a pair of powered wheels. However, in alternative embodiments two or more remote controls may be used to control a pair of powered wheels. In one embodiment, one of the remote controls is selected as a lead control unit. If any remote control issues a command in conflict with the lead control unit, then the conflicting command is ignored.

The location sensor and location identifier of the drive unit is described as using a magnet of the right integration bracket with a Hall Effect sensor. Other types of location sensors and identifiers may be used. In one embodiment, the location sensor may be a camera that detects a presence of a code on the integration bracket. The code may be a simple pattern or a QR code. Alternatively the location identifier may be a reflective region on the integration bracket and the location sensor detects the reflection. While the location identifier is described as being on the right integration bracket, the location identifier maybe located on integration bracket as long as the side is a predetermined side configured in the drive units of the powered wheels.

The powered wheels described above have been described in use with a wheelchair. However, the use of the powered wheels is not limited to wheelchair applications and can be used for other applications including applications with two, three, four or more wheels. Examples of other wheel applications includes golf buggies and wheeled trollies.

While a specific design of the plug 1800 and the socket 1850 is described above, other plug and socket designs may also be used, with the bung 1900 and the cap 2200 being adapted for the change in design.

The automated locking pin process 2500 described above may have a time out feature to prevent the hub of the powered wheel rotating continuously. In one example, the time out feature may be a predetermined number of rotations before the automated locking pin process 2500 times out and ends. In another example, the time out feature may be based on a predetermined time. If the pin engagement detection 2570 does not detect the locking pins have engaged after 30 second the automated locking pin process 2500 may stop.

In one embodiment, when the wheelchair is on a slope, a jog wheel on a remote control, such as the remote control 700, may be used to vary a braking force on the wheelchair. Moving the jog wheel in one direction may increase the braking force from the powered wheels, while moving the jog wheel in the other direction may decrease the braking force from the powered wheels.

In one embodiment the jog wheel on the remote control may provide control for an axis of the joystick or provide an offset for the axis of the joystick on the remote control, such as the remote control 700. When operating in a replacement mode, the jog wheel can replace one axis, such as forwards an backwards to move the wheelchair forwards or backwards. Alternatively, the jog wheel can replace the steering axis of the joystick, such that the wheelchair is steered with the jog wheel. When operating in the offset mode, the jog wheel may provide an offset to one axis of the joystick. For the forwards and backwards axis, the jog wheel may add an offset in the forwards or backwards directions. For the steering axis, the jog wheel may add a steering offset to the left or the right. The joystick is then used to provide additional input for the axis that the jog wheel has set the offset. In one example, the jog wheel sets an offset so that the wheelchair moves forwards slowly. The joystick can be pushed forwards to make the wheelchair move faster, or pushed backwards to slow the wheelchair or pushed further backwards to stop or move the wheelchair in reverse.

### Advantages

The described powered wheel is compatible with existing wheelchairs on the market. By varying the design of the integration brackets the powered wheels can attach and used with existing wheelchairs without extensive modification of the wheelchair. This allows additional functionality to be added to existing wheelchairs and increasing mobility options for users.

The use of wireless connectivity between each of the powered wheels and the remote control provides a truly wireless system. The powered wheels and/or a remote control may be paired to one another at time of manufacture, sale or by the user. Powered wheels or the remote control may be replaced as needed and paired to operate together.

The disclosed powered wheel is relatively light weight. In one embodiment, the powered wheel weighs 5 kg per wheel with an additional 0.5 kg for the removable battery. The low weight is advantageous for transportability and may also have a significant impact for users when in freewheel mode.

The disclosed automated locking pin process allows a user of the wheelchair to switch the wheelchair from a freewheel mode to a powered mode without having to correctly position the locking pins by moving the powered wheels. This allows the locking pins to be positioned in tight spaces and without having to move the wheelchair. This is advantageous when a wheelchair user is tired and looking to covert from freewheel mode to powered mode quickly and simply.

The bung and cap described provides a dust and liquid proof barrier to keep sockets and plugs clean. The use of the cap to remove the bung allows users with fine motor control issues to manipulate the cap into position and use the cap to remove the bung. Such an operation allows for simple removal of the bung.

The powered wheel control process, describe above, allows a user of the wheelchair to interact with the powered wheels to control the wheelchair. This provides an alternative way of interacting with the wheelchair in addition to any joystick style control. By manipulating the powered wheels, the user is able to steer the wheelchair. Further, the wheelchair is able to determine if a slope is changing a course of the wheelchair and counteract forces from the slope to maintain a heading for the wheelchair.

The powered wheel control process uses so-called sensor fusion to deduce internal and external influences on the wheelchair, without requiring any specific hardware instrumentation beyond what is provided by the powered wheel. Instead the sensor fusion synthesises estimations from an adaptive model various influences on the wheelchair motion, and allows control responses to be conditioned by these estimations. The powered wheel control process allows for a vastly improved user experience in terms of their degree of “feeing in control of” the wheelchair.

The embodiments and examples described above may be combined in various and different combinations.

The figures included herewith show aspects of non-limiting representative embodiments in accordance with the present disclosure, and particular structural elements shown in the figures may not be shown to scale or precisely to scale relative to each other. The depiction of a given element or consideration or use of a particular element number in a particular figure or a reference thereto in corresponding descriptive material can encompass the same, an equivalent, an analogous, categorically analogous, or similar element or element number identified in another figure or descriptive material associated therewith. The presence of “/” in a figure or text herein is understood to mean “and/or” unless otherwise indicated, i.e., “A/B” is understood to mean “A” or “B” or “A and B”.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

1. A drive unit of a powered wheel for a wheelchair, the drive unit comprising:
a battery for powering the drive unit;
an electric motor for driving the powered wheel; and
at least one retractable locking pin for engaging the drive unit with the wheelchair to allow the electric motor to drive the wheelchair.

2. The drive unit according to claim 1, wherein the at least one retractable locking pin engages with a locking pin receiver of an integration bracket mounted on the wheelchair.

3. The drive unit according to claim 2, wherein the at least one locking pin can be disengaged from the locking pin receiver of the integration bracket to place the powered wheel in a free wheel mode.

4. The drive unit according to claim 3, wherein the at least one locking pin is disengaged from the pin receiver by a locking mechanism located on a hub of the powered wheel.

5. The drive unit according to claim 4, wherein the locking mechanism is rotated to engage the locking pin with the locking pin receiver of the integration bracket.

6. The drive unit of claim 1, further comprising:
a location sensor for determining which side of the wheelchair the powered wheel is mounted.

7. (canceled)

8. The drive unit according to claim 6, wherein the location sensor detects a location identifier attached to the wheelchair.

9. The drive unit according to claim 8, wherein the location identifier is formed as part of an integration bracket mounted on the wheelchair.

10-12. (canceled)

13. A wheel for a wheelchair fitted with the drive unit of claim 1.

14. A method of converting a powered wheel of a wheelchair from a freewheel mode to a powered mode, the method comprising:
releasing a locking pin on the powered wheel from the freewheel mode position;
receiving a command to start a wheel lock mode for the powered wheel;
rotating a hub of the powered wheel relative to a wheel of the powered wheel; and
determining that the locking pin of the powered wheel is captured by a locking pin receiver on an integration bracket on the wheelchair to enable to powered wheel to move the wheelchair in powered mode.

15. The method according to claim 14, wherein determining that the locking pin is captured by the locking pin receiver is determined based on torque applied to a motor of the powered wheel and a position of the powered wheel.

16. The method according to claim 14, wherein the locking pin is spring loaded to enter the locking pin receiver.

17. The method according to claim 14, wherein the integration bracket depresses the locking pin to allow the locking pin to slide over the integration bracket.

18. The method according to claim 14, wherein rotating the hub has a predetermined number of rotations before timing out.

19-22. (canceled)

23. A method of controlling at least one powered wheel of a wheelchair, the method comprising:
estimating a pose contribution for motor power consumption;
estimating a surface contribution for motor power consumption;
determining a user interaction from the estimated pose contribution and the estimated surface contribution and motor data for the at least one powered wheel; and
modifying operation of a motor of the powered wheel according to the determined user interaction to control the at least one powered wheel.

24. The method according to claim 23, wherein estimating the surface contribution includes estimating a surface type on which the at least powered wheel operates.

25. The method according to claim 24, wherein the surface type determines an estimated change in power consumption for the motor.

26. The method according to claim 23, wherein determining the user interaction also includes a motion contribution from acceleration of the wheelchair.

27. The method according to claim 25, wherein determining the user interaction attributes a discrepancy between expected power used by the motor and actual power used by the motor.

28. The method according to claim 26, wherein the expected power used by the motor is determined using the estimated pose contribution and the estimated surface contribution.
